(19) United States
(12) Patent Application Publication
(10) Pub. No.: US 2026/0319869 A1
(43) Pub. Date: Oct. 15, 2026

(54) Process Diffusion System

(71) Applicant: GEORGETOWN UNIVERSITY, Washington, DC (US)

(72) Inventors: Benjamin Ujcich, Washington, DC (US); Micah Sherr, Washington, DC (US); Zhao Zhang, Washington, DC (US)

(21) Appl. No.: 19/643,524

(22) Filed: Apr. 9, 2026

Related U.S. Application Data
(60) Provisional application No. 63/786,601, filed on Apr. 10, 2025.

(51) Int. Cl. G06F 9/54

(52) U.S. Cl. CPC G06F 9/547; G06F 9/544

(57) ABSTRACT

A system for process diffusion across computing instances includes a first computing instance with a first runtime container sharing a process space with a target program, and a second computing instance with a second runtime container. A monitor component communicatively coupled to both runtime containers detects revocation notifications and issues roam and recall commands. A Remote Procedure Call channel transfers execution context data between the runtime containers. The first runtime container receives a roam command, pauses thread execution via a registered signal handler, marshals data structures containing CPU register states, and transfers the marshaled data structures and memory layout to the second runtime container. The second runtime container receives the marshaled data structures and memory layout, spawns corresponding threads, restores the data structures, and resumes execution of the target program on the second computing instance.

### CROSS-REFERENCE TO RELATED APPLICATIONS

This application claims priority to U.S. Application No. 63/786,601, titled Process Diffusion System, filed Apr. 10, 2025, which is hereby incorporated by reference in its entirety.

### FIELD OF INVENTION

The present disclosure relates to cloud computing and virtualization systems, and more particularly to systems and methods for process diffusion that enable transparent migration of program execution flows across virtual machine instances while maintaining access to resources on an original instance.

### BACKGROUND

Cloud computing has become a foundational technology for modern computing infrastructure, enabling organizations to provision and utilize computing resources on demand. Cloud providers offer various types of virtual machine instances to meet diverse customer needs, including on-demand instances that provide guaranteed availability and spot instances that offer discounted pricing in exchange for the possibility of revocation.

Spot virtual machine instances represent unused capacity that cloud providers make available at reduced prices compared to on-demand instances. However, cloud providers may revoke these spot instances at any time to reclaim the underlying resources, requiring tenants to gracefully stop their processes and save states within a short time window. That revocation characteristic limits the practical utilization of spot instances for many workloads, as tenants must implement mechanisms to handle unexpected termination events.

Managing program execution across multiple virtual machine instances presents various challenges. Process migration approaches typically require migrating complete program instances along with their environment, including program-related storage, dynamically linked libraries, and mounted file systems. Migrating such environments can be expensive and time-consuming, and may exceed the time constraints imposed by spot instance revocation windows.

Virtual machine-level migration approaches may also introduce significant interruption times. Full virtual machine migrations may require nested virtualization and can take substantial time to complete, potentially exceeding revocation time limits imposed by cloud providers. Additionally, migrations typically require users to manage storage consistency between source and destination environments.

Virtualization technologies, while providing benefits such as isolation and resource management, may also introduce performance overhead. Applications running inside guest virtual machines may experience degraded performance due to the interaction between multiple scheduling layers. Host-level schedulers may not account for guest-level schedulers operating inside virtual machines, which can result in suboptimal performance for certain workloads, particularly parallel-intensive applications.

Memory utilization in cloud environments presents additional considerations. Cloud tasks have diverse memory demands, and memory remains a constrained resource within traditional server-centric architectures. Imbalanced memory utilization across clusters can lead to situations where individual servers face memory shortages while other resources in the broader cluster remain underutilized.

Therefore, improved systems and methods for managing program execution across cloud computing environments may be desirable.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a system for process diffusion across computing instances is provided. The system includes a first computing instance comprising a first runtime container configured to share a process space with a target program executing on the first computing instance. The system includes a second computing instance comprising a second runtime container. The system includes a monitor component communicatively coupled to the first runtime container and the second runtime container. The monitor component is configured to detect a revocation notification associated with the second computing instance and issue roam commands and recall commands to the first runtime container and the second runtime container. The system includes a Remote Procedure Call (RPC) channel between the first runtime container and the second runtime container for transferring execution context data. The first runtime container is configured to receive a roam command from the monitor component. The first runtime container is configured to pause execution of one or more threads of the target program by sending a signal to each thread of the target program via a registered signal handler. The first runtime container is configured to marshal ucontext data structures containing Central Processing Unit (CPU) register states of the one or more threads of the target program. The first runtime container is configured to transfer the marshaled ucontext data structures to the second runtime container via the RPC channel. The first runtime container is configured to transfer a memory layout of the target program to the second runtime container, wherein the memory layout is obtained via a process memory map interface. The second runtime container is configured to receive the marshaled ucontext data structures and the memory layout from the first runtime container. The second runtime container is configured to spawn threads corresponding to the one or more threads of the target program. The second runtime container is configured to restore the marshaled ucontext data structures. The second runtime container is configured to resume execution of the target program on the second computing instance.

According to other aspects of the present disclosure, the system may include one or more of the following features. The first runtime container may be further configured to register a user-defined signal (SIGUSR2) handler at startup. The first runtime container may be further configured to enumerate all threads of the target program upon receiving the roam command. The first runtime container may be further configured to send the user-defined signal to each thread via a thread-specific signal delivery function (tgkill( )) to invoke the signal handler in memory regions of the first runtime container with separate stacks to prevent tampering with states of the target program. The second runtime container may comprise a userfaultfd handler thread configured to detect page fault events triggered when the target program accesses memory on the second computing instance. The userfaultfd handler thread may be configured to fetch accessed pages from the first runtime container via the RPC channel. The userfaultfd handler thread may be configured to install the fetched pages in memory on the second computing instance. The userfaultfd handler thread may be configured to wake up paused threads of the target program after page installation. The first runtime container may be further configured to examine a memory layout of the target program via a process memory map interface (/proc/maps). The first runtime container may be further configured to send the memory layout to the second runtime container without transferring underlying page contents during a roam operation. The first runtime container may be further configured to send program memory pages to a remote page cache maintained by the second runtime container. The first runtime container may be further configured to intercept system calls of the target program via a modified C library that wraps system calls with a pre-syscall handler and a post-syscall handler. The first runtime container may be further configured to execute the pre-syscall handler to perform bookkeeping, argument modification, and system call forwarding. The first runtime container may be further configured to execute the post-syscall handler after system call completion to handle bookkeeping tasks including processing return values. The second runtime container may be configured to execute system calls locally on the second computing instance when the target program is roaming. The second runtime container may be configured to forward system calls requiring access to resources on the first computing instance back to the first runtime container via the RPC channel. The first runtime container may be further configured to record thread states including thread local storage during thread creation. The first runtime container may be further configured to create a mirror thread on the first computing instance when a new thread is created on the second computing instance during roaming. The first runtime container may be further configured to manage paired threads using virtual thread identifiers. The first runtime container may be further configured to bookkeep behaviors of listening sockets, epoll file descriptors, and epoll events. The first runtime container may be further configured to restore file descriptor numbers using a file descriptor duplication function (dup2( )) when the target program roams to the second computing instance. The monitor component may be further configured to receive a spot instance termination notification associated with the second computing instance. The monitor component may be further configured to send a recall command to the second runtime container. The monitor component may be further configured to coordinate transfer of allocated memory content from the second computing instance to the first computing instance within a revocation time window. The second runtime container may be further configured to maintain a list of unmapped memory regions for reuse instead of mirroring memory unmapping system calls (munmap) back to the first runtime container. The second runtime container may trigger an implicit memory mapping system call (mmap) to the first runtime container to reserve a memory chunk when the list of unmapped memory regions is empty or has no available region for a requested size.

According to another aspect of the present disclosure, a method for process diffusion across computing instances is provided. The method includes executing a target program within a first runtime container on a first computing instance, wherein the first runtime container shares a process space with the target program. The method includes receiving, at the first runtime container, a roam command from a monitor component. The method includes pausing execution of one or more threads of the target program by sending a signal to each thread via a registered signal handler. The method includes marshaling ucontext data structures containing CPU register states of the one or more threads. The method includes transferring the marshaled ucontext data structures and a memory layout of the target program to a second runtime container on a second computing instance via an RPC channel. The method includes spawning, at the second runtime container, threads corresponding to the one or more threads of the target program. The method includes restoring the marshaled ucontext data structures at the second runtime container. The method includes resuming execution of the target program on the second computing instance.

According to other aspects of the present disclosure, the method may include one or more of the following features. The method may further include registering a user-defined signal (SIGUSR2) handler at startup of the first runtime container. The method may further include enumerating all threads of the target program upon receiving the roam command. The method may further include sending the user-defined signal to each thread via a thread-specific signal delivery function (tgkill( )) to force invocation of the signal handler in memory regions of the first runtime container with separate stacks. The method may further include detecting, at a userfaultfd handler thread of the second runtime container, page fault events triggered when the target program accesses memory on the second computing instance. The method may further include fetching accessed pages from the first runtime container via the RPC channel. The method may further include installing the fetched pages in memory on the second computing instance. The method may further include deregistering installed pages from the userfaultfd handler. The method may further include examining a memory layout of the target program via a process memory map interface (/proc/maps) at the first runtime container. The method may further include transferring the memory layout without underlying page contents to the second runtime container during a roam operation. The method may further include sending program memory pages to a remote page cache maintained by the second runtime container to reduce RPC latency for subsequent page fault handling. The method may further include intercepting system calls of the target program via a modified C library. The method may further include executing a pre-syscall handler to perform bookkeeping and argument modification. The method may further include determining whether to execute a system call locally on the second computing instance or forward the system call to the first runtime container. The method may further include executing a post-syscall handler to process return values and perform bookkeeping tasks. The method may further include receiving, at the monitor component, a revocation notification associated with the second computing instance. The method may further include sending a recall command from the monitor component to the second runtime container. The method may further include transferring allocated memory content from the second computing instance to the first computing instance within a revocation time window. The method may further include resuming execution of the target program on the first computing instance after the memory content transfer completes. The method may further include preserving opened resources including file descriptors on the first computing instance. The method may further include providing on-demand access to the preserved opened resources from the second computing instance via RPC calls. The method may further include treating the second computing instance as a diskless computation node.

According to another aspect of the present disclosure, a non-transitory computer-readable medium storing instructions that, when executed by one or more processors, cause the one or more processors to perform operations is provided. The operations include executing a target program within a first runtime container on a first computing instance, wherein the first runtime container shares a process space with the target program. The operations include receiving a roam command at the first runtime container. The operations include pausing execution of threads of the target program by sending a signal to each thread via a registered signal handler to invoke the signal handler in memory regions of the first runtime container. The operations include marshaling ucontext data structures containing CPU register states of the threads. The operations include transferring the marshaled ucontext data structures to a second runtime container on a second computing instance. The operations include examining a memory layout of the target program via a process memory map interface. The operations include transferring the memory layout to the second runtime container. The operations include spawning, at the second runtime container, threads corresponding to the threads of the target program. The operations include restoring the marshaled ucontext data structures at the second runtime container. The operations include resuming execution of the target program on the second computing instance.

According to other aspects of the present disclosure, the operations may include one or more of the following features. The operations may further include detecting, at a userfaultfd handler thread of the second runtime container, page fault events when the target program accesses memory. The operations may further include fetching accessed pages from the first runtime container via an RPC channel. The operations may further include installing the fetched pages in memory on the second computing instance. The operations may further include sending program memory pages from the first runtime container to a remote page cache maintained by the second runtime container. The operations may further include reclaiming physical memory on the first computing instance by paging out sent pages. The operations may further include receiving a revocation notification associated with the second computing instance at a monitor component. The operations may further include sending a recall command to the second runtime container. The operations may further include transferring all allocated memory content from the second computing instance to the first computing instance. The operations may further include resuming execution of the target program on the first computing instance after the allocated memory content is transferred.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1A illustrates a block diagram of a computing system with a server-centric architecture, according to aspects of the present disclosure.

FIG. 1B illustrates a block diagram of a computing system with sharable remote memory on a server-centric architecture, according to aspects of the present disclosure.

FIG. 1C illustrates a block diagram of a computing system with a disaggregated memory architecture, according to aspects of the present disclosure.

FIG. 2 illustrates a diffused workflow for managing program execution across virtual machine instances, according to aspects of the present disclosure.

FIG. 3A illustrates communication between runtime containers during roam and recall operations, according to aspects of the present disclosure.

FIG. 3B illustrates page request and transfer handling during a roaming period, according to aspects of the present disclosure.

FIG. 3C illustrates system call handling during a roaming period, according to aspects of the present disclosure.

FIG. 3D illustrates thread creation handling during a roaming period, according to aspects of the present disclosure.

FIG. 4A illustrates mean roam time as a function of the number of threads, according to aspects of the present disclosure.

FIG. 4B illustrates mean roam time as a function of data size with userfaultfd enabled, according to aspects of the present disclosure.

FIG. 4C illustrates mean recall time as a function of data size, according to aspects of the present disclosure.

FIG. 5A illustrates roaming program performance and resource utilization for a key-value store program, according to aspects of the present disclosure.

FIG. 5B illustrates roaming program performance and resource utilization for a video conversion task, according to aspects of the present disclosure.

FIG. 5C illustrates roaming program performance and resource utilization for a compression task, according to aspects of the present disclosure.

FIG. 6 illustrates a performance comparison graph for various benchmarks, according to aspects of the present disclosure.

FIG. 7A illustrates disk IO throughput measurements for EBS storage, according to aspects of the present disclosure.

FIG. 7B illustrates disk IO throughput measurements for NVMe storage, according to aspects of the present disclosure.

FIG. 8A illustrates task finish times and prices for a video conversion task, according to aspects of the present disclosure.

FIG. 8B illustrates costs for a video conversion task across different configurations, according to aspects of the present disclosure.

FIG. 8C illustrates task finish times and prices for a compression task, according to aspects of the present disclosure.

FIG. 8D illustrates costs for a compression task across different configurations, according to aspects of the present disclosure.

FIG. 9A illustrates throughput and cost metrics for baseline and diffused configurations, according to aspects of the present disclosure.

FIG. 9B illustrates latency metrics for baseline and diffused configurations, according to aspects of the present disclosure.

FIG. 10A illustrates token processing rates for different configurations, according to aspects of the present disclosure.

FIG. 10B illustrates token processing rates for different configurations, according to aspects of the present disclosure.

FIG. 10C illustrates token processing rates for different configurations, according to aspects of the present disclosure.

FIG. 11A illustrates performance comparison for a video conversion task with and without process diffusion, according to aspects of the present disclosure.

FIG. 11B illustrates performance comparison for a compression task with and without process diffusion, according to aspects of the present disclosure.

FIG. 11C illustrates request rate performance for a caching application, according to aspects of the present disclosure.

FIG. 11D illustrates latency performance for a caching application, according to aspects of the present disclosure.

FIG. 11E illustrates request rate performance for a web server application, according to aspects of the present disclosure.

FIG. 11F illustrates latency performance for a web server application, according to aspects of the present disclosure.

FIG. 12 illustrates progress over time for multiple tasks during process diffusion operations, according to aspects of the present disclosure.

FIG. 13 illustrates a block diagram of a computing device, according to aspects of the present disclosure.

FIG. 14 illustrates a system for process diffusion across multiple network domains, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

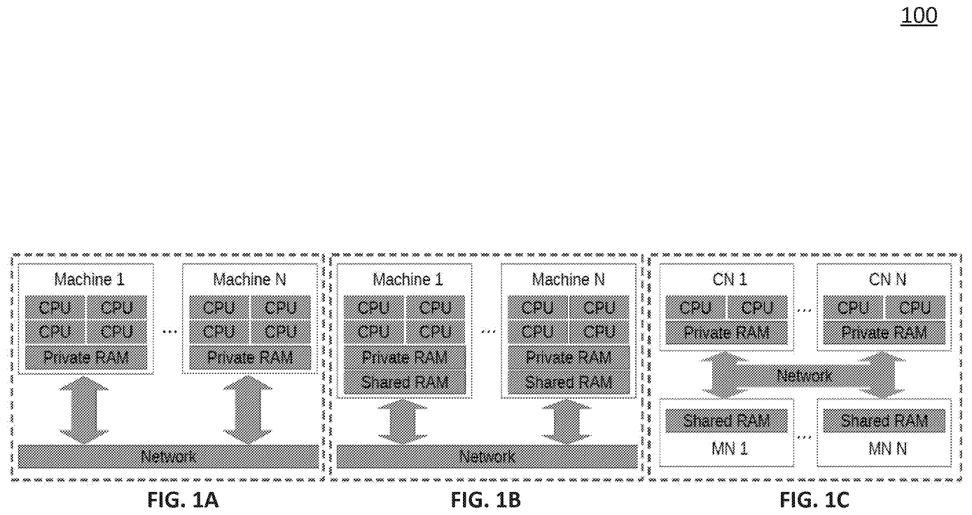

Referring to FIGS. 1A-1C, a computing system 100 depicts three different memory architecture configurations for cloud environments. The computing system 100 provides context for understanding the technical challenges associated with memory utilization and resource allocation in cloud computing infrastructure that process diffusion systems may address.

In a first configuration shown in FIG. 1A, the computing system 100 includes Machine 1 through Machine N, where each machine contains multiple Central Processing Units (CPUs) arranged in a grid pattern and Private Random Access Memory (RAM). The machines communicate via a Network connection. This first configuration represents a server-centric architecture where machines communicate via messages rather than shared memory. In server-centric architectures, each machine maintains isolated memory resources, and inter-machine communication occurs through message-passing approaches.

In a second configuration shown in FIG. 1B, the computing system 100 includes Machine 1 through Machine N, where each machine contains multiple CPUs, Private RAM, and Shared RAM. The machines communicate via a Network connection. This second configuration represents a sharable remote memory configuration on server-centric architecture where partial memory of each machine may be shared with others. The sharable remote memory configuration allows machines to expose portions of local memory for access by other machines in the cluster while retaining private memory regions for local operations.

In a third configuration shown in FIG. 1C, the computing system 100 includes Computation Nodes (CN) 1 through CN N, each containing multiple CPUs and Private RAM, connected via a Network to Memory Nodes (MN) 1 through MN N, each containing Shared RAM. This third configuration represents a disaggregated memory architecture where computation nodes are separated from memory nodes. In the disaggregated memory architecture, computation nodes may dynamically request remote memory over the network as needed, and the memory pool hides the complexities of individual machines.

The computing system 100 demonstrates the evolution from traditional server-centric architectures to disaggregated memory systems that may enable more flexible resource allocation and utilization across cloud environments. Cloud tasks have diverse memory demands, where memory-intensive applications may require substantial memory capacity, whereas virtual machines and containers may prioritize scalability and flexibility in memory usage. Memory may remain a constrained and inelastic resource within traditional server-centric architectures. In some cases, data centers may experience substantially higher memory utilization compared to CPU utilization. Even when an individual server faces memory shortages leading to Out-Of-Memory (OOM) process termination, the broader cluster may have a portion of memory resources idle and underutilized. Incorrect memory configurations for cloud workloads may exacerbate imbalanced memory utilization, potentially causing task interruptions or failures. Precise upfront memory allocation may remain impractical, as administrators may not accurately predict the dynamically changing memory requirements of workloads.

With continued reference to FIGS. 1A-1C, the computing system 100 provides foundational context for understanding how process diffusion systems may address technical problems arising specifically in cloud computing environments. The process diffusion approach described herein provides a technical solution to the problem of utilizing cross-domain resources, including CPU, memory, and network resources, across virtual machine instances. Unlike conventional approaches that may require migrating complete program instances along with program-related storage, dynamically linked libraries, and mounted file systems, process diffusion decouples the execution of a process into a pure computational execution flow that may be moved across instances and an environmental part that consists of interactions with the environment. This decoupling enables efficient roaming of a process execution flow toward a spot virtual machine instance while preserving environmental accesses with an on-demand instance, thereby improving the functioning of cloud computing infrastructure by enabling seamless utilization of resources across different instance types.

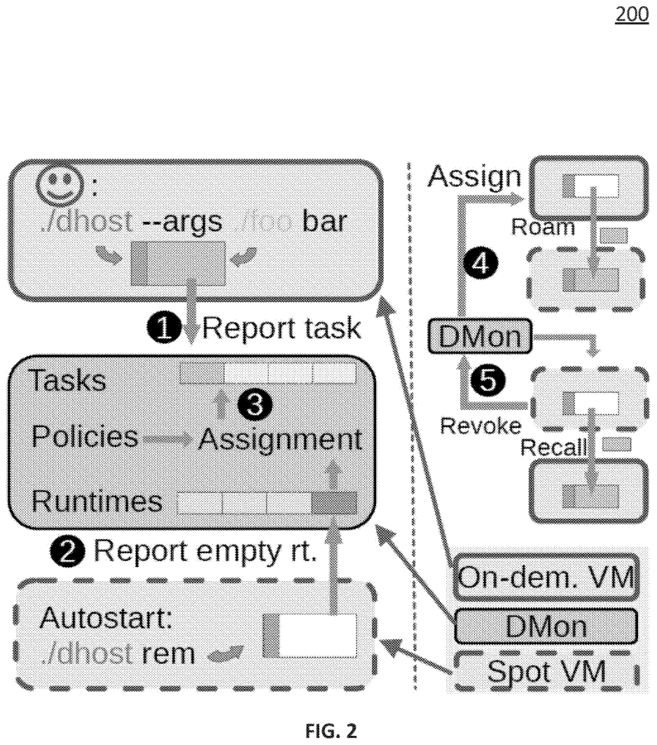

Referring to FIG. 2, a Diffused workflow 200 depicts a process diffusion system for managing program execution across virtual machine instances. The Diffused workflow 200 provides a technical solution to a technical problem arising specifically in cloud computing environments, where two features—high performance with a discount and a low-cost non-revocable guarantee—are provided by separate instances. The process diffusion approach addresses this problem by decoupling the execution of a process into a pure computational execution flow that may be moved across spot instances and an environmental part that consists of interactions with the environment, such as storage input/output (I/O), which may remain within an on-demand instance. By disentangling the process in this manner, the Diffused workflow 200 may efficiently roam a process execution flow toward a spot virtual machine (VM) instance while preserving environmental accesses with an on-demand instance.

The Diffused workflow 200 includes two components: a DHost runtime container and a DMon monitor component. The DHost runtime container operates with a shared process design where DHost shares the same process space with a target program. The shared-process design eliminates inter-process communication (IPC) overhead that would occur if DHost were to operate as a separate process and eliminates user-kernel context switches that would occur if DHost were implemented as a kernel module. By staying in an isolated space within the process, DHost may maintain separate threads, sockets, file descriptors, and other resources to manage the target program without interfering with the target program.

With continued reference to FIG. 2, the Diffused workflow 200 shows the interaction between an on-demand VM instance on a left side and spot VM instances on a right side, with the DMon monitoring component positioned between the on-demand VM instance and the spot VM instances. A user may initiate program execution using a command represented as “./dhost --args./foo bar” which launches a program foo with DHost. The DHost runtime container loads a dynamic loader, the target program, and all dependent libraries into a managed address space and transfers control to the target program.

In a first step labeled with numeral 1 in FIG. 2, a “Report task” operation occurs where the DHost runtime container reports to the DMon monitor component as a task runtime after the program starts. The DMon monitor component maintains information about tasks, policies, and runtimes. The DMon monitor component oversees both task and empty DHost runtimes and spot instance revocations.

In a second step labeled with numeral 2 in FIG. 2, a “Report empty rt.” operation occurs where a spot-side DHost runtime container reports to the DMon monitor component as an empty runtime after the spot VM spawns. The spot VM may auto-start with DHost packed into a system image. A cold-started spot instance may load the DHost runtime container from a snapshot, and the target program binary instructions and libraries may be transferred from the on-demand instance. This approach avoids installing software on spot instances, enables a diskless workflow, and avoids overhead of Elastic Block Store (EBS) cold initialization.

In a third step labeled with numeral 3 in FIG. 2, an “Assignment” operation occurs where the DMon monitor component monitors both task and empty DHost runtimes and assigns empty runtimes for tasks based on pre-defined policies. The DMon monitor component may implement various policies, such as an “assign-when-available” policy that assigns empty runtimes to tasks whenever available. The DMon monitor component exposes an Application Programming Interface (API) with roam( ) and recall( ) calls, allowing tenants to write extensible roaming and recalling policies.

In a fourth step labeled with numeral 4 in FIG. 2, an “Assign” and “Roam” operation occurs where the DMon monitor component notifies the DHost runtime container running task foo to roam and move the underlying execution to the spot instance. When the original DHost runtime container receives the roam command, the original DHost runtime container pauses the target program and copies current Central Processing Unit (CPU) context, memory layout, and thread information to the remote DHost runtime container. The remote DHost runtime container resumes the target program execution. When a process roams, CPU and physical memory usage on the original VM may be reduced. Opened resources, such as file descriptors, may be preserved on the original VM to allow on-demand access from spot instances via Remote Procedure Calls (RPCs). This design simplifies spot instance configurations, avoids the cost of replicating a program entire environment to spot instances, and treats the remote spot instances as diskless general-purpose compute nodes.

In a fifth step labeled with numeral 5 in FIG. 2, a “Revoke” and “Recall” operation occurs when the DMon monitor component receives a spot instance termination notification. The DMon monitor component sends a recall command to the remote DHost runtime container on the spot instance. A roamed process may be recalled back to the original DHost runtime container by the DMon monitor component upon revocation. This design converts the problem of creating a domain-specific spot instance revocation mechanism into recalling a roamed process within a short timeframe. After execution recall, the spot instance may be safely terminated. After a recall, the DMon monitor component may roam the process to a next available spot instance.

The Diffused workflow 200 demonstrates how the process diffusion system improves the functioning of cloud computing infrastructure by enabling seamless utilization of resources across different instance types. Unlike conventional approaches that may require migrating complete program instances along with program-related storage, dynamically linked libraries, and mounted file systems, the process diffusion approach transfers only minimal information required to diffuse the execution, including ucontext data structures of all target threads and allocated memory content. The process diffusion system may abstract away the problem of revocation handling, allowing the use of spot instances as cheaper, diskless, and replaceable computation nodes while maintaining compatibility with Linux binaries and minimizing the need to manage spot instances.

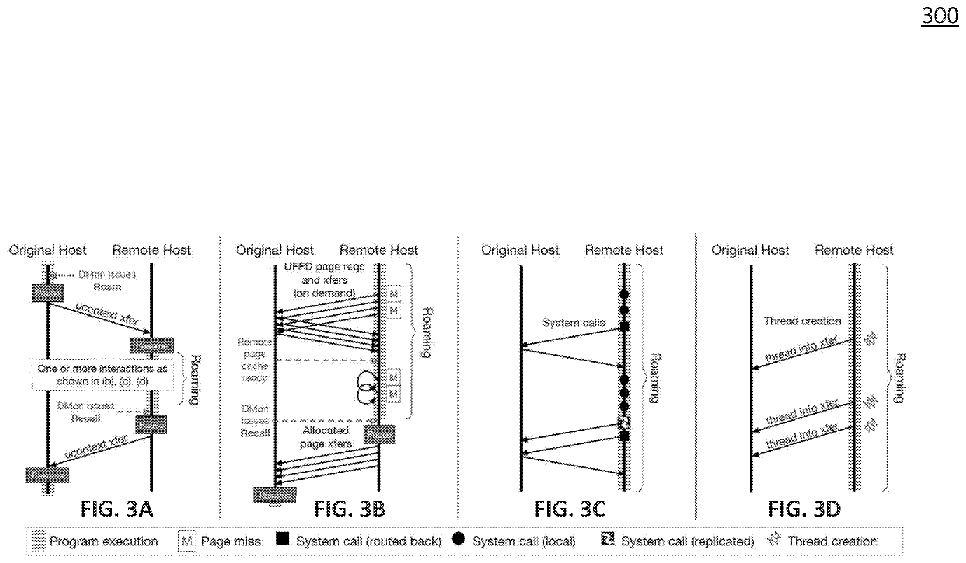

Referring to FIGS. 3A-3D, a DHost runtimes communication 300 depicts the interaction between an Original Host and a Remote Host during process diffusion operations. The DHost runtimes communication 300 illustrates four distinct communication scenarios that may occur during roam and recall operations, providing a technical solution to the problem of seamlessly transferring program execution flows across computing instances while maintaining access to resources on an original instance. The DHost runtimes communication 300 demonstrates specific technical mechanisms including ucontext transfer, userfaultfd-based memory handling, and system call interposition that enable efficient process diffusion.

With continued reference to FIG. 3A, a first communication scenario depicts the sequence of operations during roam and recall commands. The sequence may begin with a DMon monitor component issuing a Roam command to the Original Host. Upon receiving the roam command, a DHost runtime container on the Original Host may enter a Pause state. The DHost runtime container may register a user-defined signal (SIGUSR2) handler at startup. Upon receiving the roam command, the DHost runtime container may enumerate all threads of a target program and send SIGUSR2 to each thread via a thread-specific signal delivery function (tgkill( )), forcing the threads to invoke the signal handler in memory regions of the DHost runtime container with separate stacks to prevent tampering with states of the target program.

As further shown in FIG. 3A, a ucontext transfer (ucontext xfer) may be transmitted from the Original Host to the Remote Host. The ucontext data structure contains Central Processing Unit (CPU) register states of a thread and may be found inside the signal handler. The ucontext data structure may be marshaled over a Remote Procedure Call (RPC) channel to a destination DHost runtime container on the Remote Host. The DHost runtime container may send only minimal information to diffuse the execution, including the ucontext data structures of all target threads and allocated memory content. When userfaultfd (UFFD) is enabled, the DHost runtime container may send only the target program memory layout discerned by reading a process memory map interface (/proc/maps) rather than underlying page contents. The ucontext data structure may be valid across different instances as long as the CPU architecture and the virtual memory layout are compatible.

With continued reference to FIG. 3A, following the ucontext transfer, the Remote Host may enter a Resume state. The remote DHost runtime container may spawn threads corresponding to the threads of the target program, restore the marshaled ucontext data structures, and resume execution of the target program. The DHost runtimes communication 300 indicates that one or more interactions as shown in FIGS. 3B, 3C, and 3D may occur during a Roaming period when the target program executes on the Remote Host.

As further shown in FIG. 3A, when the DMon monitor component issues a Recall command, the Remote Host may enter a Pause state. Another ucontext transfer may be sent back from the Remote Host to the Original Host. Upon a recall, sending back all allocated memory in time may become a priority, and the target program may resume after all memory contents are safely sent back. After the ucontext transfer completes, the Original Host may enter a Resume state. The recall procedure may be similar to the roaming procedure, enabling the target program to be recalled to the original instance upon revocation.

Referring to FIG. 3B, a second communication scenario illustrates the handling of UFFD page requests and transfers during the Roaming period. The DHost runtime container may provide a userfaultfd-based lazy memory migration approach by making the original DHost runtime container serve as an in-place page-server. During roaming, the original side DHost runtime container may examine the target program memory layout via the process memory map interface (/proc/maps) and send the layout to the remote DHost runtime container. The remote DHost runtime container may restore the layout without transferring underlying page contents and resume execution.

With continued reference to FIG. 3B, when the target program resumes on the Remote Host and accesses memory, the target program may trigger page fault events. The page fault events may be sent to a UFFD handler thread that operates as part of the DHost runtime container. The Original Host may send UFFD page requests and transfers on demand to the Remote Host, indicated by M symbols representing page misses in FIG. 3B. The UFFD handler thread may fetch the accessed page from the original runtime container via an RPC, install the fetched page in memory on the Remote Host, and wake up paused threads of the target program. The UFFD handler thread may no longer watch an installed page after installation.

As further shown in FIG. 3B, the Remote Host may maintain a remote page cache that becomes ready to receive page transfers. To reduce RPC latency for subsequent page fault handling, the original DHost runtime container may send all program memory pages to the remote page cache maintained by the remote DHost runtime container. The original DHost runtime container may page out sent pages to reclaim physical memory on the Original Host. When the DMon monitor component issues a Recall command, the Remote Host may enter a Pause state, and allocated page transfers may be sent back to the Original Host before the Resume state is reached.

Referring to FIG. 3C, a third communication scenario depicts system call handling during the Roaming period. The DHost runtime container may intercept system calls in userspace using a modified C library that wraps system calls with a pre-syscall handler and a post-syscall handler. The pre-syscall handler may handle bookkeeping, argument modification, and system call forwarding operations. The post-syscall handler may execute after the system call finishes and handle bookkeeping tasks, such as processing return values.

With continued reference to FIG. 3C, the diagram shows system calls being processed during the Roaming period. Filled circles in FIG. 3C represent system calls executed locally on the Remote Host. The process diffusion system may prefer local system call execution on the Remote Host unless the system calls are required to be sent back to the Original Host. Squares with arrows in FIG. 3C represent system calls that are replicated or routed back to the Original Host. System calls requiring access to resources on the Original Host, such as storage and certain memory system calls, may be forwarded back to the original DHost runtime container via the RPC channel. When a system call must be sent back, the DHost runtime container may send necessary memory content following system call definitions and wait for updated memory content, return value, and error number.

As further shown in FIG. 3C, upon a roam or recall operation, the DHost runtime container may wait for unblocking system calls to finish before sending signals to corresponding threads. The DHost runtime container may modify results of some system calls for other purposes. For example, many programs may use sched_getaffinity to determine available cores, and the DHost runtime container may modify the result with available cores of a spot instance to enable programs to scale with a spot instance having more cores.

Referring to FIG. 3D, a fourth communication scenario shows thread creation handling during the Roaming period. The process diffusion system may support multithreaded programs. During thread creation, the DHost runtime container may record thread states including thread local storage to ensure the threads can be mirrored on a remote instance if the target program roams.

With continued reference to FIG. 3D, when thread creation occurs on the Remote Host during roaming, thread information transfers (thread info xfer) may be sent back to the Original Host. Wavy lines in FIG. 3D represent thread creation events on both hosts. When a roamed program creates a new thread, the DHost runtime container may create an identical sleep thread on the Original Host. The new thread on the Original Host may begin execution when the target program is recalled back. Thread termination may be noted to ensure consistency between the two DHost runtime containers. The DHost runtime container may employ a virtual thread identifier (virtual-TID) to manage paired threads across the Original Host and the Remote Host.

The DHost runtimes communication 300 demonstrates how the process diffusion system improves the functioning of cloud computing infrastructure by enabling seamless utilization of resources across different instance types. The process diffusion system may use a memory channel for memory synchronization and an RPC channel for all other communication. The channels may be built with standard TCP sockets to maximize compatibility. Nagle's algorithm may be deactivated via TCP_NODELAY for shorter latency. The process diffusion system may minimize the need to communicate by serving system calls locally when possible, thereby reducing communication overhead compared to conventional approaches that forward all system calls to a home node when a process migrates.

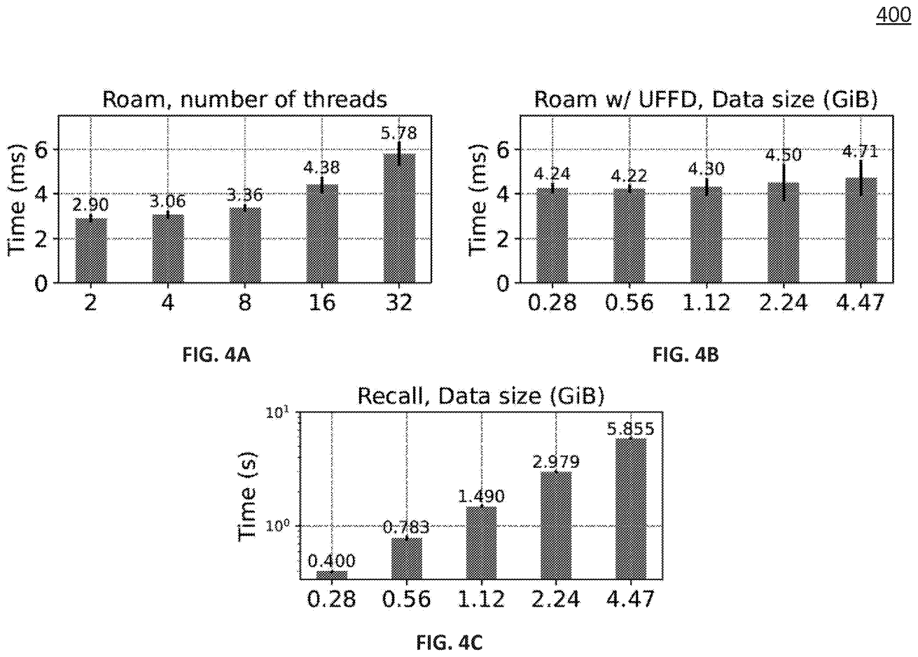

Referring to FIGS. 4A-4C, roam and recall operations 400 depict micro-benchmark graphs for a process diffusion system with userfaultfd (UFFD) enabled. The roam and recall operations 400 provide a technical solution to the problem of managing program execution transfers across computing instances within revocation time constraints imposed by cloud providers. The roam and recall operations 400 demonstrate specific performance characteristics that enable the process diffusion system to handle spot instance revocations while maintaining program execution continuity.

With continued reference to FIG. 4A, the roam and recall operations 400 illustrate mean roam time in milliseconds as a function of the number of threads. Upon roaming, a DHost runtime container may collect and marshal information of each thread of a target program. FIG. 4A shows roam time measurements for configurations with 2, 4, 8, 16, and 32 threads, with values of 2.90, 3.06, 3.36, 4.38, and 5.78 milliseconds respectively. The roam time may grow linearly with a small number of threads, exhibiting a coefficient of determination (R²) of 0.9946. With more threads, context switching may incur additional overhead. The linear scaling characteristic demonstrates that the process diffusion system may efficiently handle multithreaded programs by collecting and transferring thread context information in a predictable manner.

Referring to FIG. 4B, the roam and recall operations 400 illustrate mean roam time in milliseconds with UFFD enabled as a function of data size in gibibytes (GiB). FIG. 4B shows roam time measurements for data sizes of 0.28, 0.56, 1.12, 2.24, and 4.47 GiB, with values of 4.24, 4.22, 4.30, 4.50, and 4.71 milliseconds respectively. The roam time may not be significantly affected by the size of allocated memory when UFFD is enabled, where only the memory layout rather than underlying page contents may be transferred during a roam operation. This characteristic provides a technical improvement over conventional migration approaches that transfer complete memory contents, enabling rapid execution transfer regardless of program memory footprint.

With continued reference to FIG. 4C, the roam and recall operations 400 illustrate mean recall time in seconds as a function of data size in gibibytes using a logarithmic scale for the time axis. FIG. 4C shows recall time measurements for data sizes of 0.28, 0.56, 1.12, 2.24, and 4.47 GiB, with values of 0.400, 0.783, 1.490, 2.979, and 5.855 seconds respectively. For recall operations, the process diffusion system may send all allocated memory content back to an original computing instance, and recall time may scale linearly as a function of the size of allocated memory. For networked programs, an additional 0.5 to 1 second may be required to enumerate network-related file descriptors and events. Each graph in FIGS. 4A-4C includes error bars indicating standard deviation over multiple experiments.

The roam and recall operations 400 demonstrate that allocated memory size may dominate recall time, which may be relevant for revocation handling within cloud provider time constraints. The process diffusion system may avoid handling kernel states required by virtual machine migrations and underlying storage required by virtual machine and process migrations during a revocation window. Sending back program-allocated memory may be the dominating task during recall operations.

As further shown in FIGS. 4A-4C, to calculate a safe size of allocated memory for revocation handling, the process diffusion system may use a formula when UFFD is disabled. If a revocation notification arrives before a remote DHost runtime container resumes execution, the remote DHost runtime container may abort the roam operation safely since an original DHost runtime container may still maintain up-to-date CPU and memory states. With a revocation notification arriving after the remote DHost runtime container resumes execution, a maximum size of allocated memory M may be calculated as:

M=B·(T_{win}−T_{δ})

where B represents a memory-network-memory bandwidth between instances, T_{win} represents a revocation window length, and T_{δ} represents a lead time for specific tasks such as closing TCP sockets. The lead time T_{δ} may be approximately 5 seconds for certain operations. This formula enables cloud tenants to determine whether a program with a given memory footprint may be safely recalled within a revocation time window.

With continued reference to FIGS. 4A-4C, when UFFD is enabled, a memory page may be enumerated up to four times during a roam and recall cycle: fetched by a UFFD handler thread via a network connection, sent by an original DHost runtime container to build a remote page cache, installed by a remote side UFFD handler thread, and sent back to an original side upon recall. The DHost runtime container may take longer to recall with UFFD enabled due to the multiple enumeration operations. For memory-bound programs, UFFD may be disabled to reduce recall time and ensure safe revocation handling within time constraints.

The roam and recall operations 400 demonstrate how the process diffusion system improves the functioning of cloud computing infrastructure by providing predictable and efficient execution transfer mechanisms. Unlike conventional approaches that may require migrating complete program instances along with program-related storage, dynamically linked libraries, and mounted file systems, the process diffusion approach transfers only minimal information required to diffuse execution, including ucontext data structures of target threads and allocated memory content. The roam and recall operations 400 enable the process diffusion system to abstract away the problem of revocation handling, allowing the use of spot instances as cheaper, diskless, and replaceable computation nodes while maintaining compatibility with Linux binaries.

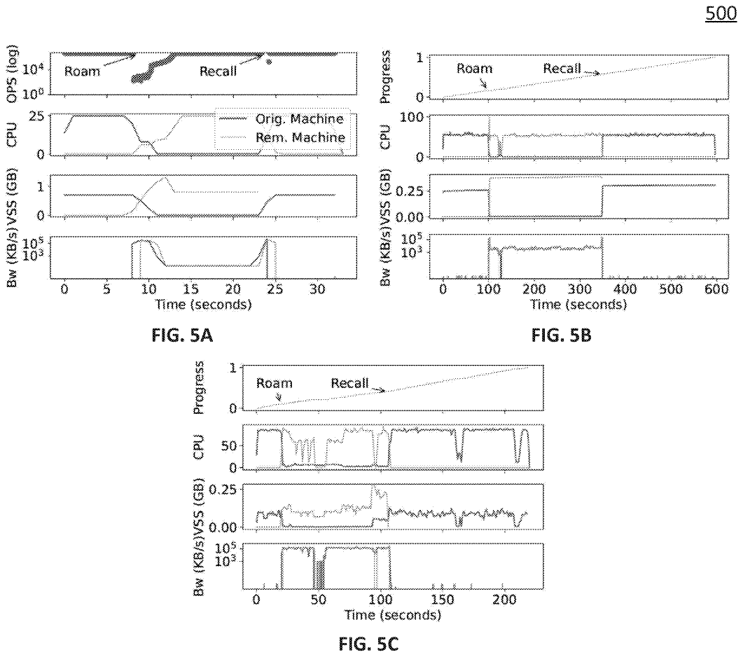

Referring to FIGS. 5A-5C, roaming program performance and resource utilization 500 depicts performance metrics and resource utilization patterns for various programs during process diffusion operations. The roaming program performance and resource utilization 500 provides a technical solution to the problem of verifying that a roamed program performs comparably to a non-roamed counterpart when executing on identical machines. The roaming program performance and resource utilization 500 demonstrates how the process diffusion system improves the functioning of cloud computing infrastructure by enabling seamless utilization of resources across different instance types while maintaining program performance.

With continued reference to FIGS. 5A-5C, the roaming program performance and resource utilization 500 illustrates performance and resource metrics for three different programs: a SimpleKV key-value store program, an FFmpeg video conversion task, and an Lbzip2 compression task. Each program may be roamed for sufficient time to reach a steady state and then recalled with userfaultfd (UFFD) enabled. The roaming program performance and resource utilization 500 records overall CPU utilization and network utilization of both an original machine and a remote machine, as well as physical memory utilization measured as virtual set size (VSS) of DHost runtime container processes from both machines.

Referring to FIG. 5A, the roaming program performance and resource utilization 500 illustrates performance metrics for a SimpleKV program configured with four threads and 10 million records totaling approximately 0.56 gibibytes (GiB). FIG. 5A shows operations per second (OPS) on a logarithmic scale, CPU utilization, VSS in gigabytes, and bandwidth in kilobytes per second over approximately 30 seconds. The process diffusion system may allow SimpleKV to operate nearly continuously during roam and recall operations. FIG. 5A depicts a two-stage slowdown after roaming, where the SimpleKV program triggers page faults and, consequently, the transfer of memory pages across machines. After a DHost runtime container sends all pages to a remote page cache, missing pages may be installed more quickly. As pages are populated on the remote host, performance may restore to levels observed before the roam operation.

With continued reference to FIG. 5A, the roaming program performance and resource utilization 500 shows data for both an original machine and a remote machine, with roam and recall events marked. When the program roams, CPU utilization and memory utilization on the original machine may drop as the computational execution flow transfers to the remote machine. The remote machine may exhibit increased CPU utilization and memory utilization corresponding to the transferred execution. Network traffic may remain continuous when programs roam since the programs report status with original side standard input/output file descriptors (STDIO-fds).

Referring to FIG. 5B, the roaming program performance and resource utilization 500 presents performance metrics for an FFmpeg video conversion task over approximately 600 seconds. FIG. 5B tracks progress, CPU utilization, VSS, and bandwidth for both the original machine and the remote machine during roam and recall operations. FFmpeg may use less memory compared to SimpleKV, making roaming and recall times less noticeable in the performance metrics. FIG. 5B demonstrates that the process diffusion system may handle CPU-intensive media conversion tasks while maintaining access to resources on the original instance.

As further shown in FIG. 5B, the FFmpeg video conversion task may generate network utilization at approximately 1 megabyte per second (MB/s) level during roaming. The lower network utilization compared to other programs may result from FFmpeg performing primarily CPU-intensive operations with minimal disk input/output (I/O) requirements during the conversion process. The roaming program performance and resource utilization 500 shows that CPU utilization shifts from the original machine to the remote machine during the roaming period and returns to the original machine during the recall operation.

Referring to FIG. 5C, the roaming program performance and resource utilization 500 shows performance metrics for an Lbzip2 compression task over approximately 200 seconds. FIG. 5C displays progress, CPU utilization, VSS, and bandwidth measurements for both the original machine and the remote machine with roam and recall events indicated. Lbzip2 may use less memory compared to SimpleKV, making roaming and recall times less noticeable in the performance metrics. The Lbzip2 compression task may trigger more disk I/O via routed system calls compared to FFmpeg.

With continued reference to FIG. 5C, the roaming program performance and resource utilization 500 demonstrates that Lbzip2 generates higher network utilization at approximately 100 MB/s level compared to FFmpeg at approximately 1 MB/s level. The higher network utilization may result from Lbzip2 triggering more disk I/O operations via system calls that are routed back to the original instance. The process diffusion system may forward storage-related system calls back to the original DHost runtime container via a Remote Procedure Call (RPC) channel, enabling the roamed program to access storage resources on the original instance.

As further shown in FIGS. 5A-5C, in each subfigure of the roaming program performance and resource utilization 500, original machine metrics are shown in a first color while remote machine metrics are shown in a second color. The roaming program performance and resource utilization 500 demonstrates how CPU and memory utilization shifts between machines during roaming operations and returns during recall operations. When a program roams, the original side CPU and memory utilization may drop as the computational execution flow transfers to the remote instance. The roamed program may primarily use remote resources, and the network may be used to route system calls that require access to resources on the original instance.

The roaming program performance and resource utilization 500 demonstrates that the process diffusion system provides a technical improvement over conventional migration approaches by decoupling the execution of a process into a pure computational execution flow that may be moved across instances and an environmental part that consists of interactions with the environment. Unlike conventional approaches that may require migrating complete program instances along with program-related storage, dynamically linked libraries, and mounted file systems, the process diffusion approach transfers only minimal information required to diffuse the execution, including ucontext data structures of target threads and allocated memory content. The roaming program performance and resource utilization 500 enables the process diffusion system to treat remote spot instances as diskless general-purpose compute nodes while preserving environmental accesses with an on-demand instance.

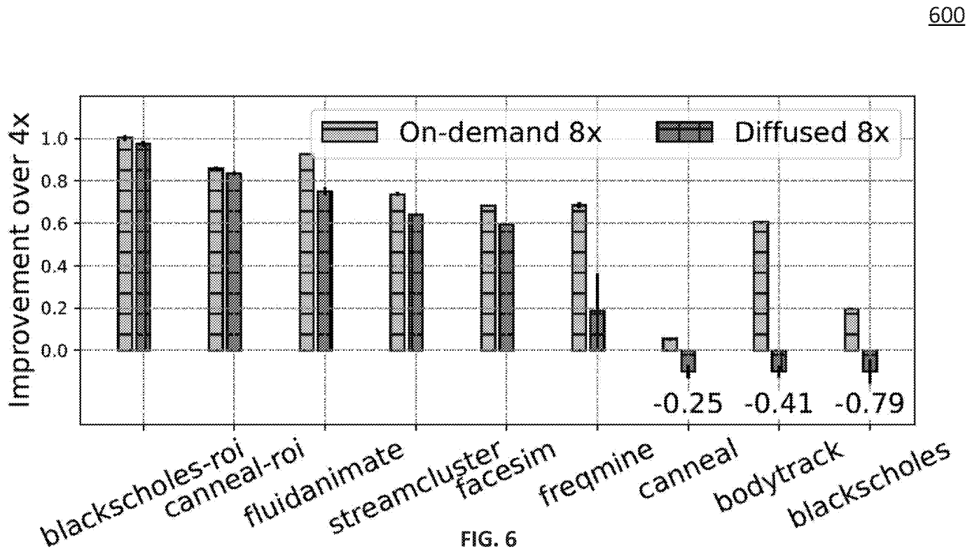

Referring to FIG. 6, a performance comparison graph 600 depicts improvement metrics for various benchmarks comparing On-demand 8× and Diffused 8× configurations over a 4× baseline. The performance comparison graph 600 provides a technical solution to the problem of verifying that multithreaded programs may scale when roaming to spot instances with more virtual Central Processing Units (vCPUs). The performance comparison graph 600 demonstrates how the process diffusion system improves the functioning of cloud computing infrastructure by enabling programs to utilize additional computational resources on spot instances while maintaining access to resources on an original instance.

With continued reference to FIG. 6, the performance comparison graph 600 illustrates benchmark results from a PARSEC 3.0 benchmark suite configured with 32 worker threads and native workloads. A baseline performance may be established by benchmarking with a first on-demand instance having 16 vCPUs. An On-demand 8× configuration may represent improvements when benchmarking with a second on-demand instance having 32 vCPUs compared to the baseline performance. A Diffused 8× configuration may represent performance improvements when roaming from a third on-demand instance having 2 vCPUs to a spot instance having 32 vCPUs, compared with the baseline performance.

As further shown in FIG. 6, the performance comparison graph 600 displays a bar chart with a vertical axis representing improvement over the 4× baseline ranging from approximately −0.79 to 1.0. A horizontal axis lists multiple benchmark programs including blackscholes-roi, canneal-roi, fluidanimate, streamcluster, facesim, freqmine, canneal, bodytrack, and blackscholes. For each benchmark, two bars are shown: a first bar representing On-demand 8× performance and a second bar representing Diffused 8× performance.

With continued reference to FIG. 6, the performance comparison graph 600 shows that for most benchmarks, both On-demand 8× and Diffused 8× configurations achieve positive improvements over the 4× baseline. The blackscholes-roi and canneal-roi benchmarks show improvements near 1.0, demonstrating scalability of multithreaded programs when roaming to instances with more vCPUs. Region Of Interest (ROI) performance may represent computation-only execution time of a benchmark without data preparation time. The ROI performance of blackscholes and canneal may demonstrate scalability when disk input/output (I/O) operations are excluded from the measurement.

As further shown in FIG. 6, the benchmarks canneal, bodytrack, and blackscholes show negative improvements for the Diffused 8× configuration, with values of approximately −0.25, −0.41, and −0.79 respectively. The On-demand 8× counterparts for canneal, bodytrack, and blackscholes show modest positive improvements. The negative improvements for the Diffused 8× configuration may result from forwarded disk I/O patterns. The blackscholes benchmark may trigger over 800,000 small disk system calls including read and writev operations with approximately 844 megabytes (MB) of data. The canneal and bodytrack benchmarks may exhibit similar disk I/O behaviors. The bodytrack-roi benchmark may be omitted from the performance comparison graph 600 since the ROI measurement for bodytrack may also capture disk I/O operations.

With continued reference to FIG. 6, the performance comparison graph 600 demonstrates that multithreaded programs without intensive disk I/O patterns may scale when roaming to spot instances with more vCPUs. The process diffusion system may forward storage-related system calls back to an original DHost runtime container via a Remote Procedure Call (RPC) channel, and forwarded disk I/O operations may introduce latency overhead compared to local disk I/O operations. Programs that trigger large numbers of small disk system calls may experience performance degradation when roaming due to the latency associated with forwarding each system call back to the original instance.

The performance comparison graph 600 demonstrates that the process diffusion system provides a technical improvement over conventional approaches by enabling programs to utilize additional computational resources on spot instances. Unlike conventional approaches that may require migrating complete program instances along with program-related storage, dynamically linked libraries, and mounted file systems, the process diffusion approach transfers only minimal information required to diffuse execution, including ucontext data structures of target threads and allocated memory content. The performance comparison graph 600 enables cloud tenants to identify workloads that may benefit from roaming to spot instances with more vCPUs while maintaining access to storage resources on an original on-demand instance.

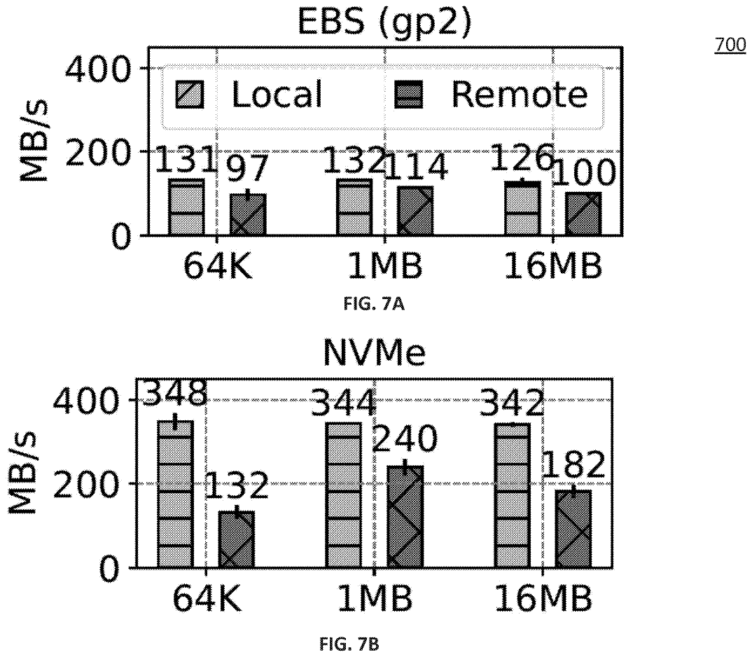

Referring to FIGS. 7A and 7B, performance comparison graphs 700 depict disk input/output (IO) throughput measurements for different storage types and block sizes. The performance comparison graphs 700 provide a technical solution to the problem of understanding the throughput characteristics of forwarded disk IO system calls when a target program roams to a remote computing instance. The performance comparison graphs 700 demonstrate how the process diffusion system improves the functioning of cloud computing infrastructure by enabling programs to access storage resources on an original instance while executing on a remote instance.

With continued reference to FIG. 7A, the performance comparison graphs 700 illustrate throughput in megabytes per second (MB/s) for Elastic Block Store (EBS) gp2 storage across different block sizes. The performance comparison graphs 700 compare Local performance against Remote performance for block sizes of 64 kilobytes (K), 1 megabyte (MB), and 16 MB. Local performance may represent disk IO throughput when a program executes without process diffusion on an original computing instance. Remote performance may represent disk IO throughput when a program roams to a remote computing instance and disk IO operations are forwarded back to the original computing instance via a Remote Procedure Call (RPC) channel.

As further shown in FIG. 7A, for the 64K block size, Local throughput measures 131 MB/s while Remote throughput measures 97 MB/s. For the 1 MB block size, Local throughput measures 132 MB/s while Remote throughput measures 114 MB/s. For the 16 MB block size, Local throughput measures 126 MB/s while Remote throughput measures 100 MB/s. The performance comparison graphs 700 demonstrate that forwarded disk IO operations may achieve throughput values that remain within a usable range compared to local disk IO operations when using EBS gp2 storage.

Referring to FIG. 7B, the performance comparison graphs 700 illustrate throughput in MB/s for Non-Volatile Memory Express (NVMe) storage across the same block sizes. For the 64K block size, Local throughput measures 348 MB/s while Remote throughput measures 132 MB/s. For the 1 MB block size, Local throughput measures 344 MB/s while Remote throughput measures 240 MB/s. For the 16 MB block size, Local throughput measures 342 MB/s while Remote throughput measures 182 MB/s.

With continued reference to FIGS. 7A and 7B, the performance comparison graphs 700 demonstrate that forwarded disk IO operations using NVMe storage may achieve similar or better throughput than local gp2 EBS throughput. The 1 MB block size may empirically achieve optimal throughput for forwarded IO operations. Smaller IO operations may experience latency overhead associated with forwarding each system call back to the original computing instance. Larger IO operations may be affected by characteristics of underlying network connections between the original computing instance and the remote computing instance.

As further shown in FIGS. 7A and 7B, the performance comparison graphs 700 may be generated by duplicating a 1.3 gigabyte (GB) file using a disk duplication utility from a computing instance with both a default gp2 EBS volume and an associated NVMe drive. The Local columns in the performance comparison graphs 700 may represent throughput measurements when running the disk duplication utility without process diffusion. The Remote columns may represent throughput measurements when roaming the disk duplication utility to a remote computing instance, causing disk IO operations to be forwarded back to the original computing instance.

The performance comparison graphs 700 demonstrate that the process diffusion system provides a technical improvement over conventional migration approaches by enabling programs to access storage resources on an original computing instance while executing computational workloads on a remote computing instance. Unlike conventional approaches that may require migrating complete program instances along with program-related storage, the process diffusion approach forwards storage-related system calls back to an original DHost runtime container via an RPC channel. The performance comparison graphs 700 enable cloud tenants to select appropriate block sizes for disk IO operations when programs roam to remote computing instances, thereby optimizing throughput for forwarded disk IO operations while maintaining access to storage resources on an original on-demand instance.

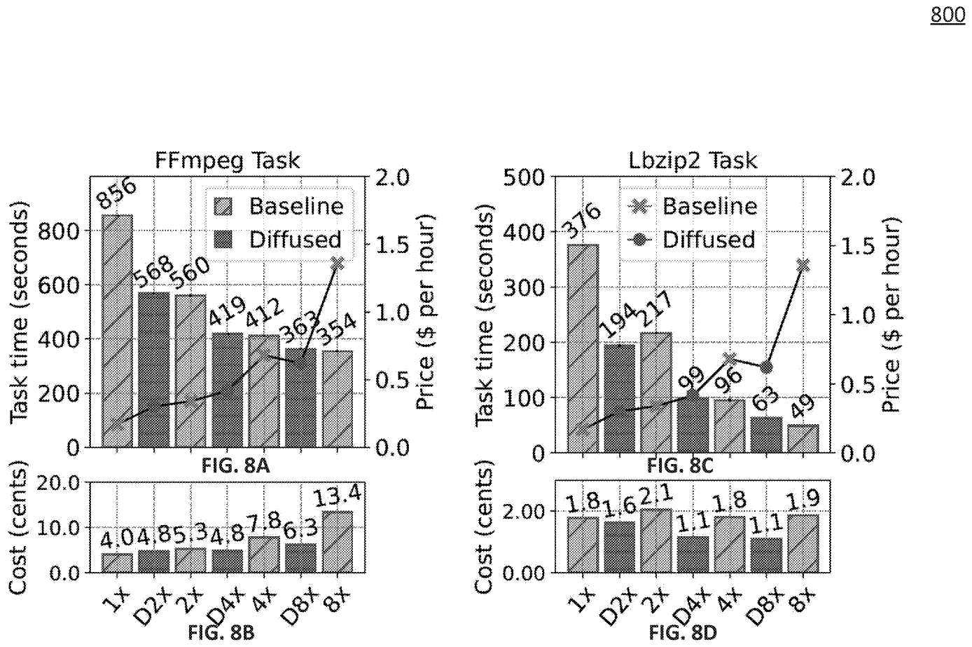

Referring to FIGS. 8A-8D, task finish times prices and costs 800 depict performance and cost metrics for running FFmpeg video conversion and Lbzip2 compression tasks across different computing instance configurations. The task finish times prices and costs 800 provide a technical solution to the problem of verifying that a process diffusion deployment may achieve performance comparable to corresponding on-demand deployments while benefiting from spot instance pricing discounts. The task finish times prices and costs 800 demonstrate how the process diffusion system improves the functioning of cloud computing infrastructure by enabling programs to utilize computational resources on spot instances while maintaining access to storage resources on an original on-demand instance.

With continued reference to FIGS. 8A-8D, the task finish times prices and costs 800 illustrate benchmark results for an FFmpeg video conversion task and an Lbzip2 compression task. The FFmpeg video conversion task may convert a video file from one format to another format using multi-threaded CPU-intensive operations. The Lbzip2 compression task may compress data using multi-threaded CPU-intensive operations. The task finish times prices and costs 800 compare baseline configurations running directly on on-demand instances against diffused configurations that roam from an on-demand instance to spot instances.

Referring to FIG. 8A, the task finish times prices and costs 800 illustrate task time in seconds for the FFmpeg video conversion task across different configurations. FIG. 8A displays a bar graph with baseline results shown in a first bar pattern and diffused results shown in a second bar pattern. The configurations may range from 1× to 8× for on-demand instances, where 1× may represent a smallest instance size and 8× may represent a largest instance size. Corresponding diffused configurations may be labeled as D2×, D4×, and D8×, where D2× may represent roaming to a 2× spot instance, D4× may represent roaming to a 4× spot instance, and D8× may represent roaming to an 8× spot instance.

As further shown in FIG. 8A, a line graph overlay shows the price in dollars per hour for each configuration. Baseline prices may be marked by a first marker type and diffused prices may be marked by a second marker type. The diffused configurations may utilize a storage-optimized on-demand instance with Non-Volatile Memory Express (NVMe) storage as an original instance and roam to compute-optimized spot instances. The baseline configurations may run directly inside compute-optimized on-demand instances with Elastic Block Store (EBS) storage.

Referring to FIG. 8B, the task finish times prices and costs 800 display a bar graph showing the cost in cents for each FFmpeg task configuration. FIG. 8B compares baseline costs against diffused costs for each configuration. The cost per task may be calculated based on the task finish time and the instance price per hour. The diffused configurations may achieve lower costs compared to corresponding on-demand configurations due to spot instance pricing discounts.

With continued reference to FIG. 8C, the task finish times prices and costs 800 present a bar graph for the Lbzip2 compression task showing task time in seconds across configurations from 1× to 8× with corresponding diffused configurations D2×, D4×, and D8×. FIG. 8C includes a price overlay line graph similar to FIG. 8A. The Lbzip2 compression task may trigger more disk input/output (I/O) operations via routed system calls compared to the FFmpeg video conversion task.

As further shown in FIG. 8C, roaming the Lbzip2 task to a spot instance may perform better than running with a corresponding on-demand instance natively in some configurations. Accessing remote NVMe storage from a storage-optimized on-demand instance may be faster than accessing local gp2 EBS storage for certain I/O rates. The process diffusion system may forward storage-related system calls back to an original DHost runtime container via a Remote Procedure Call (RPC) channel, enabling the roamed program to access NVMe storage resources on the original instance.

Referring to FIG. 8D, the task finish times prices and costs 800 show the cost in cents for each Lbzip2 task configuration, comparing baseline costs against diffused costs. The diffused configurations may achieve cost savings compared to corresponding on-demand configurations while maintaining comparable task finish times.

With continued reference to FIGS. 8A-8D, the task finish times prices and costs 800 demonstrate that running tasks under a diffused deployment may achieve similar performance approaching corresponding on-demand deployment while benefiting from spot discount pricing. The process diffusion system may allow programs such as FFmpeg and Lbzip2 to achieve up to 1.11× on-demand performance while maintaining up to 52% spot discount. The process diffusion system may speed up storage-optimized instances with cheaper compute-optimized spot instances by roaming computational workloads to spot instances while preserving access to storage resources on the original on-demand instance.

As further shown in FIGS. 8A-8D, the task finish times prices and costs 800 demonstrate that the process diffusion system provides a technical improvement over conventional approaches by decoupling the execution of a process into a pure computational execution flow that may be moved across instances and an environmental part that consists of interactions with the environment. Unlike conventional approaches that may require migrating complete program instances along with program-related storage, dynamically linked libraries, and mounted file systems, the process diffusion approach transfers only minimal information required to diffuse execution, including ucontext data structures of target threads and allocated memory content. The task finish times prices and costs 800 enable cloud tenants to identify cost-effective deployment configurations that utilize spot instance pricing while maintaining access to storage resources on an original on-demand instance.

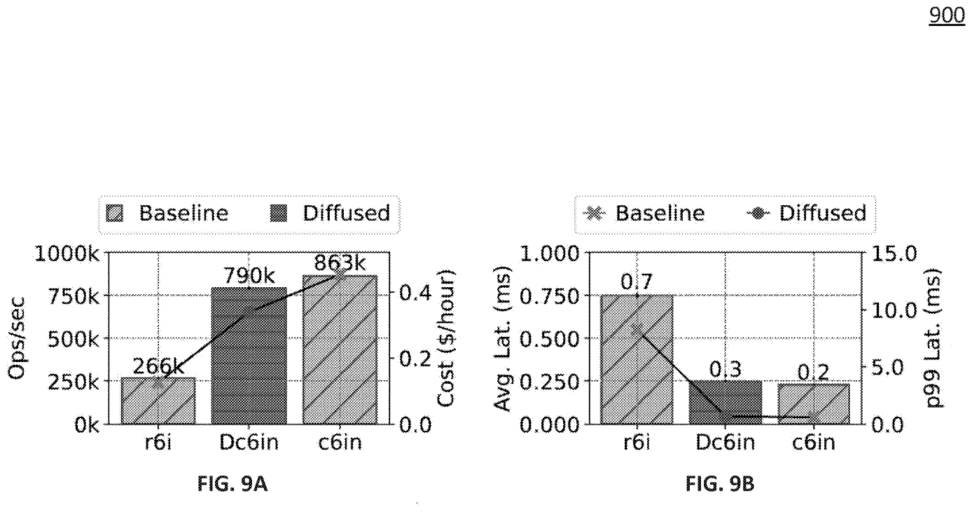

Referring to FIGS. 9A and 9B, performance comparison graphs 900 depict throughput, cost, and latency metrics for baseline and diffused configurations across different computing instance types. The performance comparison graphs 900 provide a technical solution to the problem of verifying that memory-bound programs may scale when roaming from memory-optimized on-demand instances to compute-optimized spot instances. The performance comparison graphs 900 demonstrate how the process diffusion system improves the functioning of cloud computing infrastructure by enabling memory-bound applications to utilize additional computational resources on spot instances while maintaining access to memory resources on an original instance.

With continued reference to FIG. 9A, the performance comparison graphs 900 illustrate operations per second (Ops/sec) on a left vertical axis and cost in dollars per hour on a right vertical axis for three instance type configurations: r6i, Dc6in, and c6in. A baseline configuration may be represented by a first bar pattern while a diffused configuration may be represented by a second bar pattern. The r6i instance type may represent a memory-optimized instance configuration with 2 virtual Central Processing Units (vCPUs) and 16 gibibytes (GiB) of memory. The c6in instance type may represent a compute-optimized instance configuration with 8 vCPUs and 16 GiB of memory.

As further shown in FIG. 9A, for the r6i instance type, the baseline configuration may achieve approximately 266,000 operations per second while the diffused configuration may achieve approximately 790,000 operations per second. The Dc6in instance type may show the diffused configuration achieving approximately 863,000 operations per second. A line graph may overlay the bar chart showing cost values, with baseline costs indicated by a first marker type and diffused costs indicated by a second marker type. The cost values may range from approximately 0.0 to 0.4 dollars per hour across the different instance configurations.

Referring to FIG. 9B, the performance comparison graphs 900 illustrate average latency in milliseconds on a left vertical axis and 99th percentile latency in milliseconds on a right vertical axis for the same three instance type configurations. The r6i instance type may show approximately 0.7 milliseconds average latency for the baseline configuration. The Dc6in instance type may show approximately 0.3 milliseconds average latency for the diffused configuration. The c6in instance type may show approximately 0.2 milliseconds average latency for the diffused configuration. The 99th percentile latency line may show values ranging from approximately 0.0 to 15.0 milliseconds, with the baseline configuration showing higher latency values around 10.0 milliseconds for the r6i instance type and lower values approaching 0.0 milliseconds for the c6in instance type in the diffused configuration.

With continued reference to FIGS. 9A and 9B, the performance comparison graphs 900 may be generated by benchmarking a Memcached caching application. Memcached may be configured with a memory-optimized r6i.large instance having 2 vCPUs and 16 GiB of memory and a compute-optimized c6in.2×large instance having 8 vCPUs and 16 GiB of memory. The Memcached application may be loaded with 20 million records of 640 bytes each, totaling approximately 14 GiB of data. Baseline results may be obtained by running Memcached with two threads and eight threads on the r6i and c6in instances respectively without process diffusion. Diffused results may be obtained by roaming a loaded Memcached process configured with eight threads from the r6i instance to the c6in instance.

As further shown in FIGS. 9A and 9B, the performance comparison graphs 900 demonstrate that a roamed Memcached application may scale well while reducing instance provision costs. To recall a memory-bound program safely, an on-demand instance may be a memory-optimized instance with sufficient memory capacity for the roamed program. The process diffusion system may enable memory-bound programs to utilize computational resources on compute-optimized spot instances while preserving memory resources on a memory-optimized on-demand instance.

The performance comparison graphs 900 demonstrate that the process diffusion system provides a technical improvement over conventional approaches by decoupling the execution of a process into a pure computational execution flow that may be moved across instances and an environmental part that consists of interactions with the environment. Unlike conventional approaches that may require migrating complete program instances along with program-related storage, dynamically linked libraries, and mounted file systems, the process diffusion approach transfers only minimal information required to diffuse execution, including ucontext data structures of target threads and allocated memory content. The performance comparison graphs 900 enable cloud tenants to identify deployment configurations where memory-bound applications may benefit from roaming to compute-optimized spot instances while maintaining access to memory resources on a memory-optimized on-demand instance.

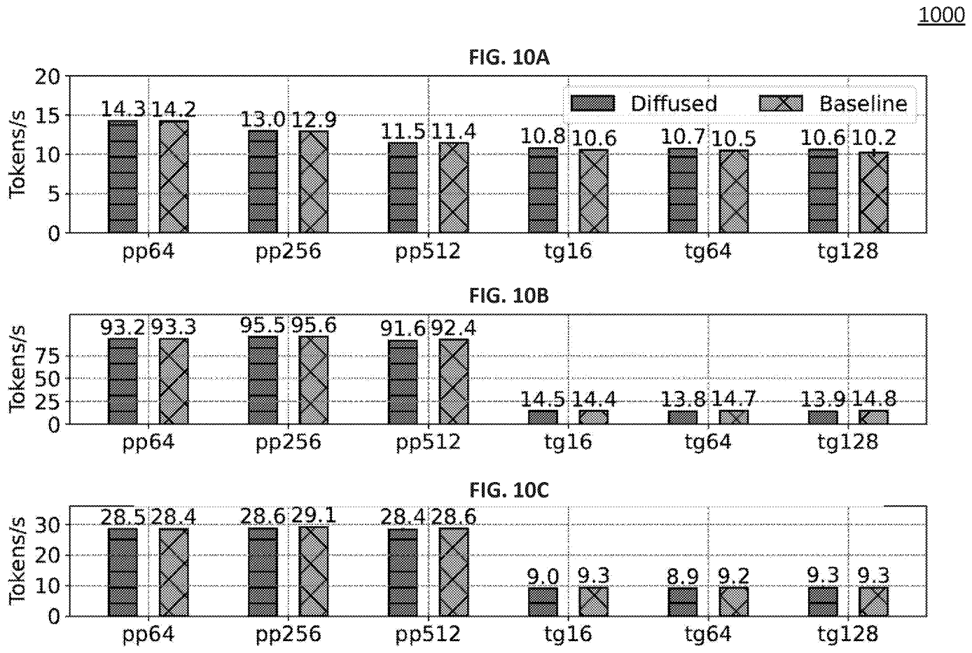

Referring to FIGS. 10A-10C, performance comparison graphs 1000 depict token processing rates for different configurations when benchmarking Large Language Model (LLM) inference workloads using a process diffusion system. The performance comparison graphs 1000 provide a technical solution to the problem of verifying that LLM inference applications may scale when roaming from smaller on-demand instances to larger spot instances. The performance comparison graphs 1000 demonstrate how the process diffusion system improves the functioning of cloud computing infrastructure by enabling LLM inference workloads to utilize additional computational resources on spot instances while maintaining access to resources on an original instance.

With continued reference to FIGS. 10A-10C, the performance comparison graphs 1000 illustrate benchmark results from a llama.cpp inference framework configured to evaluate prompt processing (pp) and text generation (tg) performance. The llama.cpp framework may provide a Central Processing Unit (CPU)-only local deployment capability for LLMs. The performance comparison graphs 1000 compare Diffused configurations against Baseline configurations across multiple test configurations including pp64, pp256, pp512, tg16, tg64, and tg128. The pp configurations may represent prompt processing operations with different prompt lengths, where pp64 may represent processing 64 tokens, pp256 may represent processing 256 tokens, and pp512 may represent processing 512 tokens. The tg configurations may represent text generation operations with different generation lengths, where tg16 may represent generating 16 tokens, tg64 may represent generating 64 tokens, and tg128 may represent generating 128 tokens.

As further shown in FIGS. 10A-10C, the performance comparison graphs 1000 display token processing rates in tokens per second for each configuration. In each of the three graphs, a Diffused configuration may be represented by solid bars and a Baseline configuration may be represented by bars with a crosshatch pattern. The Baseline configuration may represent running a llama-bench benchmark directly on a compute-optimized instance having 32 virtual Central Processing Units (vCPUs) and 64 gibibytes (GiB) of memory. The Diffused configuration may represent roaming the llama-bench benchmark from a memory-optimized instance having 4 vCPUs and 32 GiB of memory to the compute-optimized instance.

Referring to FIG. 10A, the performance comparison graphs 1000 show token processing rates ranging from approximately 10.2 to 14.3 tokens per second across the test configurations. FIG. 10A may represent benchmark results for a first LLM model configuration. The prompt processing configurations pp64, pp256, and pp512 may demonstrate token rates in a first range, while the text generation configurations tg16, tg64, and tg128 may demonstrate token rates in a second range.

With continued reference to FIG. 10B, the performance comparison graphs 1000 present token processing rates ranging from approximately 13.8 to 95.6 tokens per second across the test configurations. FIG. 10B may represent benchmark results for a second LLM model configuration. The prompt processing configurations pp64, pp256, and pp512 may demonstrate substantially higher throughput compared to the text generation configurations tg16, tg64, and tg128. The higher throughput for prompt processing configurations may result from prompt processing operations being more parallelizable across multiple CPU cores compared to text generation operations.

As further shown in FIG. 10C, the performance comparison graphs 1000 display token processing rates ranging from approximately 8.9 to 29.1 tokens per second across the test configurations. FIG. 10C may represent benchmark results for a third LLM model configuration. The prompt processing configurations pp64, pp256, and pp512 may again demonstrate higher performance compared to the text generation configurations tg16, tg64, and tg128.

With continued reference to FIGS. 10A-10C, the performance comparison graphs 1000 may be generated by benchmarking llama.cpp with a builtin llama-bench utility against multiple LLM models including a Meta-Llama-3.1-8B model with 8-bit quantization and a DeepSeek-R1-Distilled-Qwen-14B model with 6-bit quantization. When both the original instance and the destination instance use the same CPU architecture, a kernel parameter may be disabled to achieve higher prompt processing token rates. For example, the prompt processing token rate for a pp64 configuration may increase from approximately 14.3 tokens per second to approximately 93.2 tokens per second when the kernel parameter is disabled.

As further shown in FIGS. 10A-10C, the performance comparison graphs 1000 demonstrate that a roamed llama-bench benchmark may achieve similar token generation rates compared to running the llama-bench benchmark natively on a larger instance. The process diffusion system may enable LLM inference applications to be deployed to spot instances without requiring domain-specific revocation handling mechanisms since the model for inference may remain unchanged and input/output data may be small and redirected to other locations. Roaming an LLM inference application may be faster than loading the model from an Elastic Block Store (EBS) snapshot by avoiding EBS initialization overhead.

The performance comparison graphs 1000 demonstrate that the process diffusion system provides a technical improvement over conventional approaches by enabling LLM inference workloads to utilize computational resources on spot instances while preserving access to memory resources on an original on-demand instance. Unlike conventional approaches that may require migrating complete program instances along with program-related storage, dynamically linked libraries, and mounted file systems, the process diffusion approach transfers only minimal information required to diffuse execution, including ucontext data structures of target threads and allocated memory content. The performance comparison graphs 1000 enable cloud tenants to identify deployment configurations where LLM inference applications may benefit from roaming to compute-optimized spot instances while maintaining access to memory resources on a memory-optimized on-demand instance, thereby reusing existing memory-optimized or storage-optimized on-demand instances and avoiding management of detachable EBS volumes.

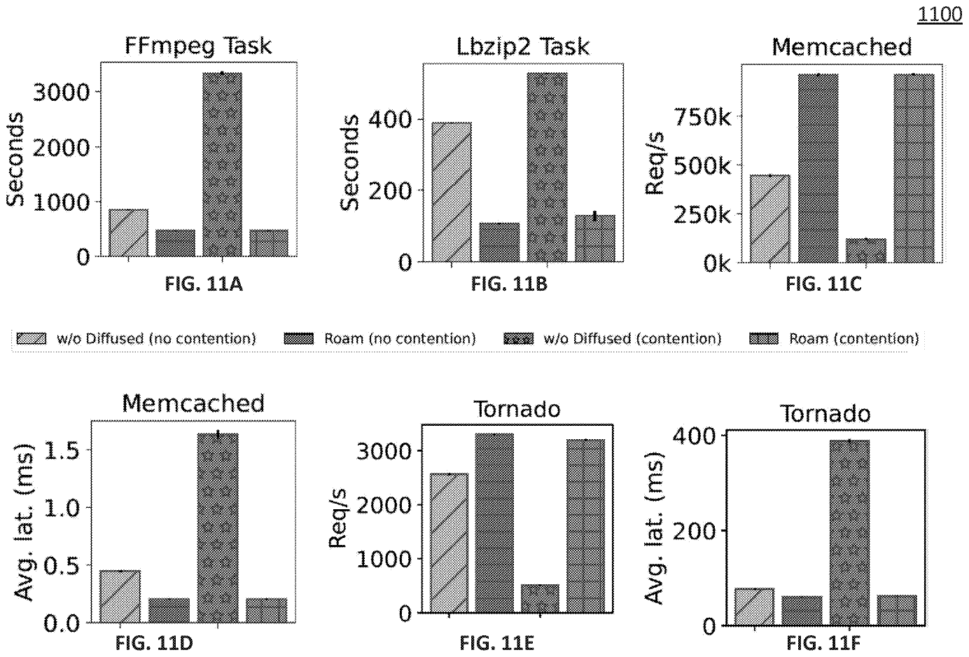

Referring to FIGS. 11A-11F, performance comparison graphs 1100 depict transparent scaling with spot instances under various conditions. The performance comparison graphs 1100 provide a technical solution to the problem of verifying that programs may benefit from performance improvements when roaming to more powerful spot instances, including scenarios where an original computing instance experiences resource contention. The performance comparison graphs 1100 demonstrate how the process diffusion system improves the functioning of cloud computing infrastructure by enabling programs to utilize additional computational resources on spot instances while the original instance remains available for recall operations.

With continued reference to FIGS. 11A-11F, the performance comparison graphs 1100 illustrate benchmark results for four different programs: an FFmpeg video conversion task, an Lbzip2 compression task, a Memcached caching application, and a Tornado web server application. The performance comparison graphs 1100 compare four conditions for each program: execution without process diffusion under no contention, execution with roaming under no contention, execution without process diffusion under contention, and execution with roaming under contention. Contention conditions may be simulated using a stress utility configured with Central Processing Unit (CPU) stressors to overload the original computing instance.

Referring to FIG. 11A, the performance comparison graphs 1100 illustrate task finish time in seconds for an FFmpeg video conversion task. FIG. 11A displays a bar chart with a vertical axis representing seconds ranging from 0 to approximately 3000 seconds. The FFmpeg video conversion task may be a multi-threaded CPU-intensive media conversion operation. When the original computing instance experiences no contention, the FFmpeg task may complete in a baseline time without process diffusion. When the FFmpeg task roams to a more powerful spot instance under no contention conditions, the FFmpeg task may complete in a reduced time compared to the baseline. When the original computing instance experiences contention from CPU stressors, the FFmpeg task may take substantially longer to complete without process diffusion. When the FFmpeg task roams to a spot instance under contention conditions, the FFmpeg task may benefit from a performance boost by utilizing idle computational resources on the spot instance.

With continued reference to FIG. 11B, the performance comparison graphs 1100 illustrate task finish time in seconds for an Lbzip2 compression task. FIG. 11B displays a bar chart with a vertical axis representing seconds ranging from 0 to approximately 400 seconds. The Lbzip2 compression task may be a multi-threaded CPU-intensive compression operation. Similar to the FFmpeg task shown in FIG. 11A, the Lbzip2 task may benefit from a performance boost when roaming to a more powerful spot instance, even when the original computing instance is overloaded with CPU stressors. The process diffusion system may forward storage-related system calls back to an original DHost runtime container via a Remote Procedure Call (RPC) channel, enabling the roamed Lbzip2 task to access storage resources on the original instance while utilizing computational resources on the spot instance.

Referring to FIG. 11C, the performance comparison graphs 1100 illustrate request rate performance in requests per second (Req/s) for a Memcached caching application. FIG. 11C displays a bar chart with a vertical axis representing requests per second ranging from 0 to approximately 750,000 requests per second. The Memcached caching application may be a multi-threaded memory-bound application. When the Memcached application roams to a more powerful spot instance, the Memcached application may achieve higher request rates compared to execution on the original computing instance. The performance improvement may result from the Memcached application utilizing additional CPU cores available on the spot instance while maintaining access to memory resources.

As further shown in FIG. 11D, the performance comparison graphs 1100 illustrate average latency in milliseconds for the Memcached caching application. FIG. 11D displays a bar chart with a vertical axis representing average latency ranging from 0.0 to approximately 1.5 milliseconds. When the Memcached application roams to a spot instance, the average latency may decrease compared to execution on the original computing instance under contention conditions. The reduced latency may result from the Memcached application executing on idle CPU cores of the spot instance rather than competing for CPU resources with other processes on the original computing instance.

Referring to FIG. 11E, the performance comparison graphs 1100 illustrate request rate performance in requests per second for a Tornado web server application. FIG. 11E displays a bar chart with a vertical axis representing requests per second ranging from 0 to approximately 3000 requests per second. The Tornado web server application may be a single-threaded web framework. Unlike the multi-threaded FFmpeg, Lbzip2, and Memcached applications, the single-threaded Tornado application may not scale with additional CPU cores available on the spot instance under no contention conditions. The single-threaded nature of the Tornado application may limit the performance improvement achievable through roaming to instances with more CPU cores.

With continued reference to FIG. 11F, the performance comparison graphs 1100 illustrate average latency in milliseconds for the Tornado web server application. FIG. 11F displays a bar chart with a vertical axis representing average latency ranging from 0 to approximately 400 milliseconds. When the original computing instance experiences contention from CPU stressors, the Tornado application may experience substantially increased latency without process diffusion. When the Tornado application roams to a spot instance under contention conditions, the Tornado application may benefit from a remote idle CPU core of the spot instance, resulting in reduced latency compared to execution on the overloaded original computing instance. The performance improvement for the single-threaded Tornado application under contention conditions demonstrates that the process diffusion system may provide benefits even for applications that do not scale with additional CPU cores.

As further shown in FIGS. 11A-11F, the performance comparison graphs 1100 demonstrate that when roaming to a more powerful spot instance, multi-threaded applications such as FFmpeg, Lbzip2, and Memcached may benefit from a performance boost by utilizing additional computational resources available on the spot instance. The performance boost may occur even when the original computing instance is overloaded with CPU stressors. Single-threaded applications such as Tornado may not scale with more CPU cores but may benefit from a remote idle CPU core of the spot instance when the original computing instance experiences resource contention.

The performance comparison graphs 1100 demonstrate that the process diffusion system provides a technical improvement over conventional approaches by enabling transparent scaling of program execution across computing instances. Unlike conventional approaches that may require migrating complete program instances along with program-related storage, dynamically linked libraries, and mounted file systems, the process diffusion approach transfers only minimal information required to diffuse execution, including ucontext data structures of target threads and allocated memory content. The process diffusion system may enable cloud tenants to scale program performance by roaming computational workloads to spot instances while preserving access to resources on an original on-demand instance, thereby improving the functioning of cloud computing infrastructure by enabling seamless utilization of resources across different instance types.

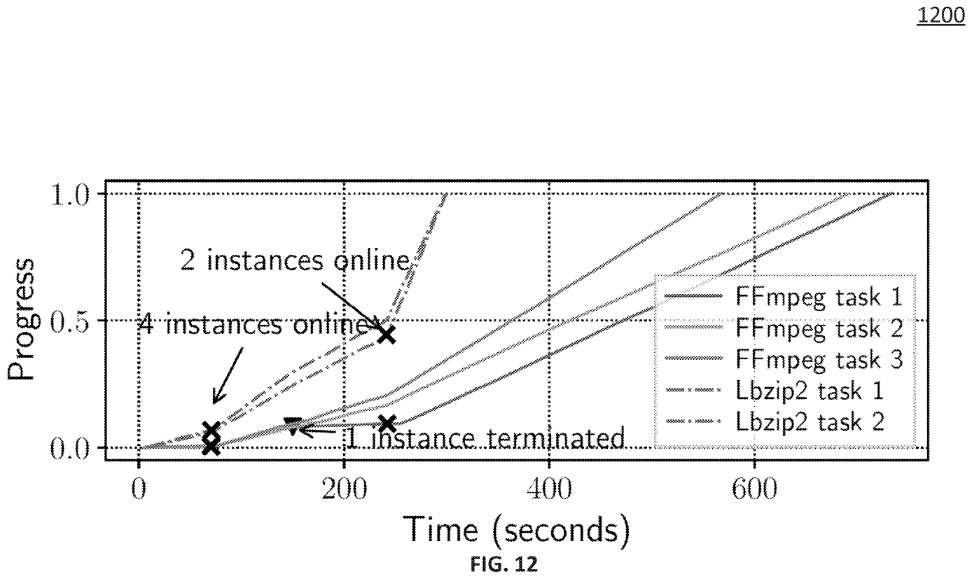

Referring to FIG. 12, a graph 1200 depicts progress over time for multiple tasks during process diffusion operations. The graph 1200 provides a technical solution to a technical problem arising specifically in cloud computing environments, where multiple programs may need to be balanced across computing instances for improved resource utilization. The graph 1200 demonstrates how the process diffusion system improves the functioning of cloud computing infrastructure by enabling automatic orchestration of multiple tasks across spot instances while handling revocation events transparently.

With continued reference to FIG. 12, the graph 1200 includes a vertical axis representing progress from 0.0 to 1.0 and a horizontal axis representing time in seconds extending beyond 600 seconds. The graph 1200 displays five different task traces: FFmpeg task 1, FFmpeg task 2, FFmpeg task 3, Lbzip2 task 1, and Lbzip2 task 2. The FFmpeg tasks may represent multi-threaded CPU-intensive media conversion operations, and the Lbzip2 tasks may represent multi-threaded CPU-intensive compression operations. The task traces demonstrate varying progress rates, with the Lbzip2 tasks showing steeper progress curves compared to the FFmpeg tasks due to differences in computational requirements and input/output characteristics.

As further shown in FIG. 12, the graph 1200 includes annotations indicating events during execution. The annotations show when instances come online and when instances are terminated. A first annotation may indicate when 4 instances come online, a second annotation may indicate when 2 instances come online, and a third annotation may indicate when 1 instance is terminated. The annotations demonstrate how the process diffusion system responds to dynamic changes in spot instance availability during task execution.

With continued reference to FIG. 12, the graph 1200 illustrates a scenario where multiple tasks may be started from an original computing instance. When no remote DHost runtimes are available at the beginning of execution, the tasks may overload each other on the original computing instance. The DMon monitor component may implement a policy to roam all tasks when idle DHost runtimes become available and recall affected roamed programs upon revocation notification. When spot instances spawn and report empty DHost runtimes to the DMon monitor component, the DMon monitor component may roam tasks to the available spot instances, reducing pressure on the original computing instance.

As further shown in FIG. 12, when a spot instance is terminated, the DMon monitor component may receive a revocation notification and send a recall command to the affected DHost runtime container on the spot instance. The affected task may be recalled to the original computing instance. The recalled task may run slower on the original computing instance when the recalled task competes for CPU resources with other tasks still executing locally. When additional spot instances become available, the DMon monitor component may roam the recalled task and other local tasks to the newly available spot instances, allowing all tasks to run faster by utilizing distributed computational resources.

The graph 1200 demonstrates that the process diffusion system provides a technical improvement over conventional approaches by enabling automatic handling of spot instance revocations without requiring domain-specific revocation mechanisms for each application. Unlike conventional approaches that may require tenants to implement custom revocation handling logic for each program, the process diffusion approach abstracts away the problem of revocation handling by converting the revocation handling task into recalling a roamed process within a revocation time window. The DMon monitor component may scale programs toward available spot instances, and tenants may remain unaware of revocation events occurring during task execution. After a recall operation completes, the DMon monitor component may roam the recalled process to a next available spot instance when additional spot instances become available.

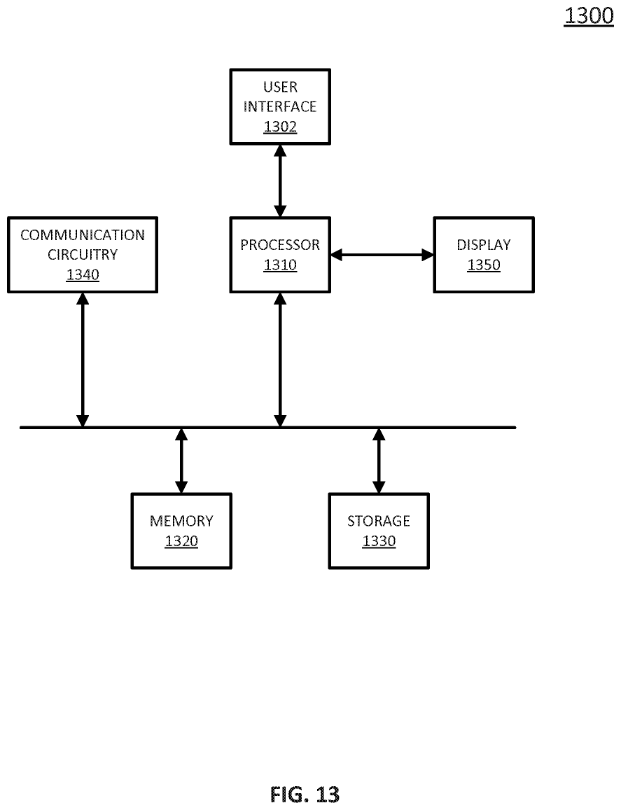

Referring to FIG. 13, a computing device 1300 depicts a block diagram of hardware components that may be configured to implement process diffusion operations. The computing device 1300 provides a technical solution to a technical problem arising specifically in cloud computing environments, where computing devices may need to manage execution flows across multiple computing instances, handle system calls, and coordinate memory consistency between original and remote runtime environments. The computing device 1300 demonstrates how process diffusion techniques may improve the functioning of cloud computing infrastructure by enabling seamless utilization of resources across different computing instances.

With continued reference to FIG. 13, the computing device 1300 includes a user interface 1302, a processor 1310, memory 1320, storage 1330, communication circuitry 1340, and a display 1350. The processor 1310 may be centrally positioned within the computing device 1300 and may be connected to each of the other components. The processor 1310 may coordinate operations among the user interface 1302, the communication circuitry 1340, the display 1350, the memory 1320, and the storage 1330 to perform the functions of the computing device 1300.

As further shown in FIG. 13, the user interface 1302 may be coupled to the processor 1310 and may provide a mechanism for user input and interaction with the computing device 1300. The user interface 1302 may include input devices such as keyboards, pointing devices, touch-sensitive surfaces, or other input mechanisms that enable users to initiate program execution, configure process diffusion parameters, and interact with runtime containers executing on the computing device 1300.

Referring again to FIG. 13, the memory 1320 may be coupled to the processor 1310 and may store data and instructions for immediate access by the processor 1310 during operation. The memory 1320 may include Random Access Memory (RAM) configured to store ucontext data structures containing Central Processing Unit (CPU) register states of threads during process diffusion operations. The memory 1320 may maintain memory layouts of target programs obtained via a process memory map interface. The memory 1320 may also store marshaled execution context data during roam and recall operations between runtime containers.

With continued reference to FIG. 13, the storage 1330 may be coupled to the processor 1310 and may provide persistent storage for data and applications. The storage 1330 may store runtime container executables, target program binaries, and dependent libraries. The storage 1330 may maintain program-related data that may be accessed by roamed processes via Remote Procedure Call (RPC) channels. The storage 1330 may include Elastic Block Store (EBS) volumes, Non-Volatile Memory Express (NVMe) drives, or other persistent storage media.

As further shown in FIG. 13, the communication circuitry 1340 may be coupled to the processor 1310 and may enable the computing device 1300 to communicate with external devices or networks. The communication circuitry 1340 may establish RPC channels between runtime containers on different computing instances for transferring execution context data. The communication circuitry 1340 may implement memory channels for memory synchronization and RPC channels for system call forwarding. The communication circuitry 1340 may utilize standard Transmission Control Protocol (TCP) sockets with Nagle's algorithm deactivated via TCP_NODELAY for reduced latency during process diffusion operations.

Referring again to FIG. 13, the display 1350 may be coupled to the processor 1310 and may provide visual output to a user. The display 1350 may present status information regarding process diffusion operations, including roam and recall progress, memory utilization metrics, and system call handling statistics. The display 1350 may render user interfaces for configuring process diffusion policies and monitoring runtime container states.

With continued reference to FIG. 13, the computing device 1300 may be configured to implement process diffusion operations. The processor 1310 may execute instructions stored in the memory 1320 to manage execution flows across multiple computing instances. The processor 1310 may execute a DHost runtime container that shares a process space with a target program. The processor 1310 may pause execution of threads of the target program by sending signals to each thread via a registered signal handler. The processor 1310 may marshal ucontext data structures containing CPU register states of the threads and may transfer the marshaled ucontext data structures to a remote runtime container via the communication circuitry 1340.

As further shown in FIG. 13, the computing device 1300 may handle system calls during process diffusion operations. The processor 1310 may intercept system calls of a target program via a modified C library that wraps system calls with a pre-syscall handler and a post-syscall handler. The processor 1310 may execute system calls locally when the target program is roaming to a remote computing instance, or may forward system calls requiring access to resources on an original computing instance back to an original runtime container via the communication circuitry 1340. The processor 1310 may execute the pre-syscall handler to perform bookkeeping, argument modification, and system call forwarding operations.

Referring again to FIG. 13, the computing device 1300 may coordinate memory consistency between original and remote runtime environments. The memory 1320 may maintain a remote page cache that receives program memory pages from an original runtime container. The processor 1310 may execute a userfaultfd handler thread configured to detect page fault events triggered when a target program accesses memory. The userfaultfd handler thread may fetch accessed pages from an original runtime container via the communication circuitry 1340, install the fetched pages in the memory 1320, and wake up paused threads of the target program after page installation.

With continued reference to FIG. 13, the computing device 1300 may execute a DMon monitor component that monitors runtime containers and coordinates process diffusion based on policies and revocation notifications. The processor 1310 may receive spot instance termination notifications via the communication circuitry 1340 and may send recall commands to remote runtime containers. The processor 1310 may coordinate transfer of allocated memory content from a remote computing instance to the computing device 1300 within a revocation time window. The computing device 1300 may resume execution of a target program after memory content transfer completes.

As further shown in FIG. 13, the computing device 1300 may be implemented as a virtual machine instance, a physical server, a cloud computing instance, or other computing platform capable of executing process diffusion operations. The computing device 1300 may operate as an on-demand instance that maintains opened resources including file descriptors for on-demand access from spot instances via RPC calls. The computing device 1300 may also operate as a spot instance that receives roamed execution flows and executes computational workloads while forwarding storage-related system calls back to an original computing instance.

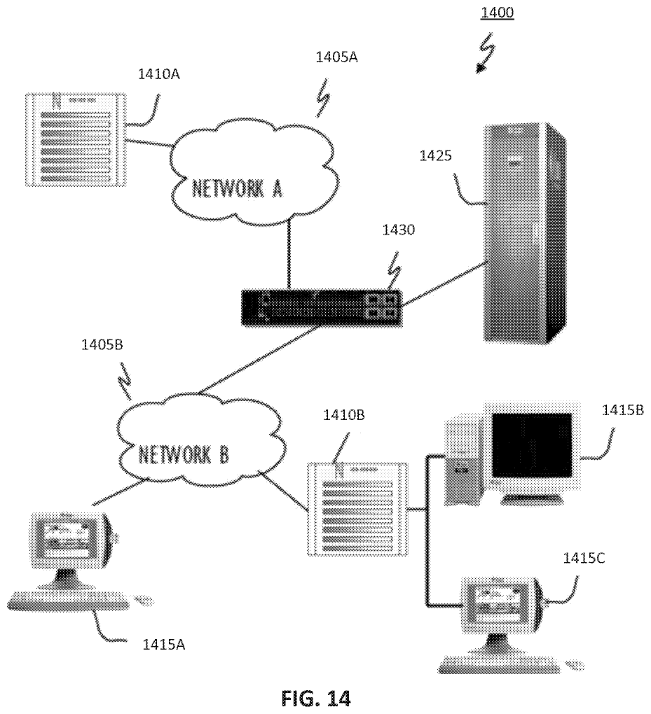

Referring to FIG. 14, a system 1400 depicts an architecture for process diffusion across multiple network domains. The system 1400 provides a technical solution to a technical problem arising specifically in distributed computing environments, where execution flows and data may need to be transferred across different network domains while maintaining access to resources distributed across the network infrastructure. The system 1400 demonstrates how process diffusion techniques may improve the functioning of cloud computing infrastructure by enabling transparent utilization of cross-domain resources including Central Processing Unit (CPU), memory, and network resources.

With continued reference to FIG. 14, the system 1400 includes two separate networks designated as Network A and Network B. Network A may represent a first network domain containing computing resources and data storage components. Network B may represent a second network domain containing additional computing resources and client devices. The separation between Network A and Network B may represent physical or logical boundaries between different network domains, where accessing resources across different domains may introduce additional overhead and complexity compared to accessing resources within a local domain.

As further shown in FIG. 14, within Network A, a first document 1410A may be connected via a first network connection 1405A to a server 1425. The first network connection 1405A may be represented as a cloud shape indicating a network pathway that facilitates data transmission between the first document 1410A and the server 1425. The server 1425 may be a computing device configured to process and manage data within the system 1400. The server 1425 may execute runtime containers configured to share a process space with target programs and may coordinate process diffusion operations across the network domains.

Referring again to FIG. 14, a network switch 1430 may be connected to the server 1425. The network switch 1430 may facilitate data routing and communication between components within the system 1400. The network switch 1430 may route execution context data, memory content, and system call information between computing instances located in different network domains. The network switch 1430 may enable the server 1425 to communicate with components in Network B.

With continued reference to FIG. 14, within Network B, a second document 1410B may be connected via a second network connection 1405B to the network switch 1430. The second network connection 1405B may be represented as a cloud shape indicating another network pathway. The second network connection 1405B may enable data transfer between Network B components and the network switch 1430, thereby providing connectivity to the server 1425 in Network A. The first document 1410A and the second document 1410B may represent data resources that may be accessed by computing instances during process diffusion operations.

As further shown in FIG. 14, the system 1400 includes multiple client devices distributed across the network infrastructure. A first client device 1415A may be positioned within Network B and may be connected to the network infrastructure. A second client device 1415B may be connected to the network switch 1430, enabling access to server resources and data. A third client device 1415C may also be connected within Network B, providing additional access points to the system 1400. The client devices 1415A, 1415B, and 1415C may execute runtime containers configured to receive roamed execution flows from the server 1425 or other computing instances.

Referring again to FIG. 14, the network topology of the system 1400 demonstrates connectivity between Network A and Network B through the network switch 1430 and the server 1425. Data may flow from the documents 1410A and 1410B through the respective network connections 1405A and 1405B to the server 1425 and the network switch 1430. The server 1425 and the network switch 1430 may then distribute information to the client devices 1415A, 1415B, and 1415C. The network topology may enable process diffusion by allowing execution flows and data to be transferred across different network domains.

With continued reference to FIG. 14, the system 1400 may enable process diffusion operations across the network domains by decoupling the execution of a process into a pure computational execution flow that may be moved across instances and an environmental part that consists of interactions with the environment. The server 1425 may maintain opened resources including file descriptors that may be preserved for on-demand access from client devices via Remote Procedure Call (RPC) channels. The client devices 1415A, 1415B, and 1415C may operate as diskless computation nodes that receive roamed execution flows while forwarding storage-related system calls back to the server 1425.

As further shown in FIG. 14, the system 1400 may utilize a memory channel for memory synchronization and an RPC channel for other communication between computing instances across the network domains. The memory channel and the RPC channel may be built with standard Transmission Control Protocol (TCP) sockets to maximize compatibility across the network infrastructure. Nagle's algorithm may be deactivated via TCP_NODELAY for reduced latency during process diffusion operations across the network domains.

Referring again to FIG. 14, the system 1400 may support roaming of program execution between instances while maintaining access to resources across the network infrastructure. When a target program roams from the server 1425 to one of the client devices 1415A, 1415B, or 1415C, the system 1400 may transfer ucontext data structures containing CPU register states and memory layout information via the network connections 1405A and 1405B. The receiving client device may spawn threads corresponding to threads of the target program, restore the marshaled ucontext data structures, and resume execution of the target program.

With continued reference to FIG. 14, the system 1400 may handle system calls during process diffusion operations across the network domains. System calls that may be executed locally on a client device may be processed without forwarding to the server 1425. System calls requiring access to resources on the server 1425, such as storage-related system calls, may be forwarded back to the server 1425 via the RPC channel traversing the network connections 1405A and 1405B. The selective system call handling may reduce communication overhead compared to approaches that forward all system calls across network domains.

As further shown in FIG. 14, the system 1400 may coordinate recall operations when a roamed process needs to return to the server 1425. A monitor component may receive revocation notifications or other triggers and may send recall commands to runtime containers on the client devices 1415A, 1415B, or 1415C. The recall operation may transfer allocated memory content from the client device back to the server 1425 via the network connections 1405A and 1405B. The target program may resume execution on the server 1425 after the memory content transfer completes.

The system 1400 demonstrates that the process diffusion approach provides a technical improvement over conventional approaches by enabling transparent utilization of cross-domain resources across multiple network domains. Unlike conventional approaches that may require migrating complete program instances along with program-related storage, dynamically linked libraries, and mounted file systems, the process diffusion approach transfers only minimal information required to diffuse execution, including ucontext data structures of target threads and allocated memory content. The system 1400 may enable computing instances to utilize resources across different network domains while maintaining compatibility with existing network protocols and application layers.

With continued reference to FIG. 14, the process diffusion system may include additional implementation considerations that address specific technical challenges arising in cloud computing environments. The additional implementation considerations may provide technical solutions to problems associated with network connection handling, memory constraints, library linkage requirements, and roaming topology limitations.

Referring again to FIG. 14, the process diffusion system may handle networked programs by executing network-related system calls in place when a target program roams to a remote computing instance. A DHost runtime container may bookkeep behaviors of all listening sockets, epoll file descriptors (epollfds), and epoll events. The DHost runtime container may restore the bookkeeping information when the target program roams, including restoring file descriptor numbers using a file descriptor duplication function (dup2( )). Existing data connections may be interrupted at an operating system level using a socket statistics command with a kill option (ss-k). The process diffusion system may keep the target program running for an additional five to ten seconds after issuing the socket kill command, allowing the target program to gracefully close data sockets before pausing execution. The heuristic may be based on the principle that network communication operates in a best-effort manner where connections may be interrupted unexpectedly, and networked programs may be designed to handle disrupted connections correctly.

As further shown in FIG. 14, the process diffusion system may support network mobility through elastic network interfaces. Cloud providers may provide elastic network interfaces that enable detachment and re-attachment of secondary network interfaces to different computing instances. A target program may listen to a wildcard address such as 0.0.0.0 to avoid handling different interface Internet Protocol (IP) addresses across instances. The elastic network interface support may enable the process diffusion system to maintain network connectivity when a target program roams between computing instances in different network domains.

A number of implementations have been described. Nevertheless, it will be understood that various modifications may be made without departing from the spirit and scope of the disclosure. Accordingly, other implementations are within the scope of the following claims.

1. A system for process diffusion across computing instances, comprising:
a first computing instance comprising a first runtime container configured to share a process space with a target program executing on the first computing instance;
a second computing instance comprising a second runtime container;
a monitor component communicatively coupled to the first runtime container and the second runtime container, the monitor component configured to:
detect a revocation notification associated with the second computing instance; and
issue roam commands and recall commands to the first runtime container and the second runtime container;
a Remote Procedure Call (RPC) channel between the first runtime container and the second runtime container for transferring execution context data; and
wherein the first runtime container is configured to:
receive a roam command from the monitor component;
pause execution of one or more threads of the target program by sending a signal to each thread of the target program via a registered signal handler;
marshal data structures containing Central Processing Unit (CPU) register states of the one or more threads of the target program;
transfer the marshaled data structures to the second runtime container via the RPC channel; and
transfer a memory layout of the target program to the second runtime container;
wherein the second runtime container is configured to:
receive the marshaled data structures and the memory layout from the first runtime container;
spawn threads corresponding to the one or more threads of the target program;
restore the marshaled data structures; and
resume execution of the target program on the second computing instance.

2. The system of claim 1, wherein the first runtime container is further configured to:
register a user-defined signal handler at startup;
enumerate all threads of the target program upon receiving the roam command; and
send the user-defined signal to each thread via a thread-specific signal delivery function to invoke the signal handler in memory regions of the first runtime container with separate stacks to prevent tampering with states of the target program.

3. The system of claim 1, wherein the second runtime container comprises a handler thread configured to:
detect page fault events triggered when the target program accesses memory on the second computing instance;
fetch accessed pages from the first runtime container via the RPC channel;
install the fetched pages in memory on the second computing instance; and
wake up paused threads of the target program after page installation.

4. The system of claim 3, wherein the first runtime container is further configured to:
examine a memory layout of the target program;
send the memory layout to the second runtime container without transferring underlying page contents during a roam operation; and
send program memory pages to a remote page cache maintained by the second runtime container.

5. The system of claim 1, wherein the first runtime container is further configured to:
intercept system calls of the target program and wrap system calls with a pre-syscall handler and a post-syscall handler;
execute the pre-syscall handler to perform bookkeeping, argument modification, and system call forwarding; and
execute the post-syscall handler after system call completion to handle bookkeeping tasks including processing return values.

6. The system of claim 5, wherein the second runtime container is configured to:
execute system calls locally on the second computing instance when the target program is roaming; and
forward system calls requiring access to resources on the first computing instance back to the first runtime container via the RPC channel.

7. The system of claim 1, wherein the first runtime container is further configured to:
record thread states including thread local storage during thread creation;
create a mirror thread on the first computing instance when a new thread is created on the second computing instance during roaming; and
manage paired threads using virtual thread identifiers.

8. The system of claim 1, wherein the first runtime container is further configured to:
bookkeep behaviors of sockets and, file descriptors; and
restore file descriptor numbers using a file descriptor duplication function when the target program roams to the second computing instance.

9. The system of claim 1, wherein the monitor component is further configured to:
receive a spot instance termination notification associated with the second computing instance;
send a recall command to the second runtime container; and
coordinate transfer of allocated memory content from the second computing instance to the first computing instance within a revocation time window.

10. The system of claim 1, wherein the second runtime container is further configured to maintain a list of unmapped memory regions for reuse instead of mirroring memory unmapping system calls back to the first runtime container, and wherein the second runtime container triggers an implicit memory mapping system call to the first runtime container to reserve a memory chunk when the list of unmapped memory regions is empty or has no available region for a requested size.

11. A method for process diffusion across computing instances, comprising:
executing a target program within a first runtime container on a first computing instance, wherein the first runtime container shares a process space with the target program;
receiving, at the first runtime container, a roam command from a monitor component;
pausing execution of one or more threads of the target program by sending a signal to each thread via a registered signal handler;
marshaling data structures containing CPU register states of the one or more threads;
transferring the marshaled data structures and a memory layout of the target program to a second runtime container on a second computing instance via an RPC channel;
spawning, at the second runtime container, threads corresponding to the one or more threads of the target program;
restoring the marshaled data structures at the second runtime container; and
resuming execution of the target program on the second computing instance.

12. The method of claim 11, further comprising:
registering a user-defined signal handler at startup of the first runtime container;
enumerating all threads of the target program upon receiving the roam command; and
sending the user-defined signal to each thread via a thread-specific signal delivery function to force invocation of the signal handler in memory regions of the first runtime container with separate stacks.

13. The method of claim 11, further comprising:
detecting, at a handler thread of the second runtime container, page fault events triggered when the target program accesses memory on the second computing instance;
fetching accessed pages from the first runtime container via the RPC channel;
installing the fetched pages in memory on the second computing instance; and
deregistering installed pages from the handler thread.

14. The method of claim 11, further comprising:
examining a memory layout of the target program at the first runtime container;
transferring the memory layout without underlying page contents to the second runtime container during a roam operation; and
sending program memory pages to a remote page cache maintained by the second runtime container to reduce RPC latency for subsequent page fault handling.

15. The method of claim 11, further comprising:
intercepting system calls of the target program;
executing a pre-syscall handler to perform bookkeeping and argument modification;
determining whether to execute a system call locally on the second computing instance or forward the system call to the first runtime container; and
executing a post-syscall handler to process return values and perform bookkeeping tasks.

16. The method of claim 11, further comprising:
receiving, at the monitor component, a revocation notification associated with the second computing instance;
sending a recall command from the monitor component to the second runtime container;
transferring allocated memory content from the second computing instance to the first computing instance within a revocation time window; and
resuming execution of the target program on the first computing instance after the memory content transfer completes.

17. The method of claim 11, further comprising:
preserving opened resources including file descriptors on the first computing instance;
providing on-demand access to the preserved opened resources from the second computing instance via RPC calls; and
treating the second computing instance as a diskless computation node.

18. A non-transitory computer-readable medium storing instructions that, when executed by one or more processors, cause the one or more processors to perform operations comprising:
executing a target program within a first runtime container on a first computing instance, wherein the first runtime container shares a process space with the target program;
receiving a roam command at the first runtime container;
pausing execution of threads of the target program by sending a signal to each thread via a registered signal handler to invoke the signal handler in memory regions of the first runtime container;
marshaling data structures containing CPU states of the threads;
transferring the marshaled data structures to a second runtime container on a second computing instance;
examining a memory layout of the target program via a process memory map interface;
transferring the memory layout to the second runtime container;
spawning, at the second runtime container, threads corresponding to the threads of the target program;
restoring the marshaled data structures at the second runtime container; and
resuming execution of the target program on the second computing instance.

19. The non-transitory computer-readable medium of claim 18, wherein the operations further comprise:
detecting, at a handler thread of the second runtime container, page fault events when the target program accesses memory;
fetching accessed pages from the first runtime container via an RPC channel;
installing the fetched pages in memory on the second computing instance;
sending program memory pages from the first runtime container to a remote page cache maintained by the second runtime container; and
reclaiming physical memory on the first computing instance by paging out sent pages.

20. The non-transitory computer-readable medium of claim 18, wherein the operations further comprise:
receiving a revocation notification associated with the second computing instance at a monitor component;
sending a recall command to the second runtime container;
transferring all allocated memory content from the second computing instance to the first computing instance; and
resuming execution of the target program on the first computing instance after the allocated memory content is transferred.
